(19) United States
(12) Patent Application Publication
(10) Pub. No.: US 2020/0110260 A1
(43) Pub. Date: Apr. 9, 2020

(54) SCANNER WITH TWO SEQUENTIAL SCAN UNITS

(71) Applicant: Blickfeld GmbH, Muenchen (DE)

(72) Inventors: Florian Petit, Muenchen (DE); Mathias Mueller, Groebenzell (DE)

(21) Appl. No.: 16/496,865

(22) PCT Filed: Mar. 22, 2018
(86) PCT No.: PCT/DE2018/100254

§ 371 Date: Sep. 23, 2019

(30) Foreign Application Priority Data
Mar. 24, 2017 (DE) 10 2017 002 866.4

(51) Int. Cl. G02B 26/10; G02B 7/182; G02B 26/08; G01S 7/481

(52) U.S. Cl. CPC G02B 26/105; G02B 26/101; G01S 7/4817; G02B 26/0858; G02B 7/182

(57) ABSTRACT

A scanner (90) comprises a first mirror (150) having a reflective front side (151) and a rear side (152), a first elastic mounting (100) which extends on a side facing the rear side (152) of the first mirror (150), a second mirror (150) having a reflective front side (151) and a rear side (152), and a second elastic mounting (100) which extends on a side facing the rear side (152) of the second mirror (150). The scanner (90) is configured to deflect light (180) sequentially at the front side (151) of the first mirror (150) and at the front side (151) of the second mirror (150).

### TECHNICAL FIELD

Various examples generally relate to a scanner for light. In particular, several examples relate to a laser light scanner that may be used, for example, for LIDAR measurements.

### BACKGROUND

The distance measurement of objects is desirable in various fields of technology. For example, in the context of autonomous driving applications, it may be desirable to detect environmental objects of vehicles and, in particular, to determine a distance to the objects.

One technique for measuring the distance of objects is the so-called LIDAR technology (light detection and ranging, sometimes also LADAR). For this purpose, for example, pulsed laser light is emitted by an emitter. The environmental objects reflect the laser light. These reflections can then be measured. By determining the transit time of the laser light, a distance to the objects can be determined.

In order to detect the environmental objects spatially resolved, it may be possible to scan the laser light. Depending on the radiation angle of the laser light different environmental objects can be detected.

In various examples, it may be desirable to perform a LIDAR measurement at particularly high resolution. For example, it may be desirable to capture two-dimensional (2-D) surroundings in the context of the LIDAR measurement. For this purpose, a 2-D scan area is implemented. In addition, it may be desirable to radiate the laser light at well-defined angles. By such parameters, for example, a lateral resolution of the LIDAR measurement is set.

For example, reference implementations use multiple vertically spaced lasers to implement a 2-D scan area. However, such techniques are expensive and require significant space for the multiple lasers. In addition, a resolution along the direction of the plurality of lasers is typically comparatively limited: reference implementations have, for example, a resolution of between 4 and 64 dots in this direction.

In addition, with highly integrated reference implementations, it is often impossible, or only possible to a limited extent, to monitor the emission angle of the laser light. Therefore, a lateral resolution can be comparatively small. Time drifts can occur.

### BRIEF DESCRIPTION OF THE INVENTION

Therefore, there is a need for improved techniques for scanning light. In particular, there is a need for improved techniques to implement LIDAR measurements.

This object is solved by the features of the independent claims. The features of the dependent claims define embodiments.

A scanner comprises a first mirror. The first mirror comprises a reflective front side and a rear side. The scanner also comprises a first elastic mounting. The first elastic mounting extends on a side facing the rear side of the first mirror, e. g. away from the rear side of the first mirror. The scanner also comprises a second mirror. The second mirror comprises a reflective front side and a rear side. The scanner also comprises a second elastic mounting. The second elastic mounting extends on a side facing the rear side of the second mirror, e. g. away from the rear side of the second mirror. The scanner is configured to deflect light sequentially at the front side of the first mirror and at the front side of the second mirror.

By using two mirrors, an optical path can be defined, which is sequentially deflected first at the reflective front side of the first mirror and then at the reflective front side of the second mirror. This allows a 2-D scan area to be implemented.

Sometimes, the at least one elastic mounting may also be referred to as an elastic support element or scan module, because it provides an elastic connection between a base—which defines a reference coordinate system, in which e. g. a light source for emitting the light may be arranged—and a deflection unit; the deflection unit may designate a moving coordinate system with respect to the reference coordinate system.

By the first elastic mounting and the second elastic mounting each extending from the rear side of the first mirror and the second mirror, respectively, a particularly high degree of integration for the scanner with the two mirrors can be achieved. In particular, compared to reference implementations in which mountings are mounted laterally in the mirror plane, it may be possible to arrange the first mirror and the second mirror particularly close to each other. As a result, it can also be achieved that a particularly large detection aperture with respect to a detector is achieved by the first mirror and the second mirror. For example, at a significant scan angle of the first mirror, the optical path may no longer centrically hit the second mirror. The greater the distance between the mirrors, the greater is this eccentricity. This reduces the detection aperture.

A scanner comprises at least one elastically moved scanning unit. This scanning unit is configured to deflect light twice by means of a first degree of freedom of movement and a second degree of freedom of movement. The scanner also comprises at least one actuator. The scanner also comprises a controller, such as an FPGA, microcontroller or ASIC. The controller is configured to drive the at least one actuator to excite the first degree of freedom of movement according to a periodic amplitude modulation function. The amplitude modulation function has alternately arranged ascending flanks and descending flanks. A length of the ascending flanks is at least twice as large as a length of the descending flanks, optionally at least four times as large, further optionally at least ten times as large. Alternatively, a length of the descending flanks could be at least twice as large as a length of the ascending flanks, optionally at least four times as large, further optionally at least ten times as large.

A scanner comprises at least one elastically moved scanning unit. This scanning unit is configured to deflect light twice by means of a first degree of freedom of movement and a second degree of freedom of movement. The scanner also comprises at least one actuator. This actuator is configured to excite the first degree of freedom of motion according to a periodic amplitude modulation function. The amplitude modulation function has alternately arranged ascending flanks and descending flanks.

Preferably, a length of the ascending flanks is at least twice as long as a length of the descending flanks, optionally at least four times as large, and further optionally at least ten times as large. Alternatively, a length of the descending flanks could be at least twice as large as a length of the ascending flanks, optionally at least four times as large, further optionally at least ten times as large.

The elastic scanning unit is sometimes referred to as a flexure scanning unit. The degrees of freedom of movement can be provided by reversible deformation, i. e. elasticity. Typically, the degrees of freedom of the motion are resonantly excited.

For example, in some examples, the scanner could comprise two elastically-moved scanning units. Each of the two elastically moved scanning units could have a mirror with a reflective front side and a rear side, and in each case an associated elastic mounting.

By means of such techniques it can be achieved that a superposition figure of the movement according to the first degree of freedom and the movement according to the second degree of freedom for implementing a 2-D scan area is implemented. Dead times during scanning can be reduced by the particularly short descending flanks. This makes it possible to scan the 2-D scan area with a high temporal resolution. This means that a repetition rate for several consecutive LIDAR images can be particularly large.

One method comprises controlling at least one actuator. At least one actuator is configured to excite a first degree of freedom of movement of at least one elastically moving scanning unit according to a periodic amplitude modulation function. The periodic amplitude modulation function comprises alternately arranged ascending flanks and descending flanks. The at least one elastically moved scanning unit further comprises a second degree of freedom of movement. The at least one elastically moved scanning unit deflects light twice by means of the first degree of freedom of movement and by means of the second degree of freedom of movement. A length of the ascending flanks is at least twice as long as a length of the descending flanks, optionally at least four times as large, further optionally at least ten times as large. Alternatively, it would also be possible for a length of the descending flanks to be at least twice as long as a length of the ascending flanks, optionally at least four times as large, further optionally at least ten times as large.

A computer program product comprises program code that can be executed by a controller. Executing the program code causes the controller to perform a method. The method comprises controlling at least one actuator. The at least one actuator is configured to excite a first degree of freedom of movement of at least one elastically moved scanning unit according to a periodic amplitude modulation function. The periodic amplitude modulation function comprises alternately arranged ascending flanks and descending flanks. The at least one elastically moved scanning unit further comprises a second degree of freedom of movement. The at least one elastically moved scanning unit deflects light twice by means of the first degree of freedom of movement and by means of the second degree of freedom of movement. A length of the ascending flanks is at least twice as long as a length of the descending flanks, optionally at least four times as large, further optionally at least ten times as large. Alternatively, it would also be possible for a length of the descending flanks to be at least twice as long as a length of the ascending flanks, optionally at least four times as large, further optionally at least ten times as large.

A computer program comprises program code that can be executed by a controller. Executing the program code causes the controller to perform a method. The method comprises controlling at least one actuator. The at least one actuator is configured to excite a first degree of freedom of movement of at least one elastically moved scanning unit according to a periodic amplitude modulation function. The periodic amplitude modulation function comprises alternately arranged ascending flanks and descending flanks. The at least one elastically moved scanning unit further comprises a second degree of freedom of movement. The at least one elastically moved scanning unit deflects light twice by means of the first degree of freedom of movement and by means of the second degree of freedom of movement. A length of the ascending flanks is at least twice as long as a length of the descending flanks, optionally at least four times as large, further optionally at least ten times as large. Alternatively, it would also be possible for a length of the descending flanks to be at least twice as long as a length of the ascending flanks, optionally at least four times as large, further optionally at least ten times as large.

A scanner comprises a scanning unit with an elastic element. The elastic element extends between a base and a deflection element. The scanning unit is configured to deflect light by means of torsion of the elastic element at the deflection unit at different angles. The scanner also comprises a magnet. This magnet is configured to generate a stray magnetic field. The scanner also comprises an angular magnetic field sensor arranged in the stray magnetic field. The angular magnetic field sensor is configured to output a signal indicative of the torsion.

The torsion can correspond to a corresponding degree of freedom of movement of the elastic element. The torsion may be provided by elastic deformation of the elastic element.

By the combination of the magnet and the angular magnetic field sensor, it is possible to closely monitor the rotation of the deflection unit due to the torsion. As a result, the angle at which the light is deflected, can be closely monitored. As a result, the radiation angle of the light can be monitored closely. As a result, the lateral resolution, for example of a LIDAR measurement, can be increased. This may be desirable in particular if the scanner comprises two scanning units, each with an associated elastic element and a deflection unit, at which an optical path of the light is sequentially deflected. Without corresponding monitoring, there may be an increased inaccuracy in the radiation angle.

The features set out above and features, which are described below, can be used not only in the corresponding combinations explicitly set out, but also in other combinations or isolated, without departing from the scope of the present invention.

### BRIEF DESCRIPTION OF THE FIGURES

FIG. 1 schematically illustrates a scanning unit according to various examples.

FIG. 2 schematically illustrates a scanning unit according to various examples.

FIG. 3 schematically illustrates a scanning unit according to various examples.

FIG. 4 schematically illustrates a scanning unit according to various examples.

FIG. 5 schematically illustrates actuators for exciting degrees of freedom of movement of the scanning units according to FIGS. 1-4.

FIG. 6 schematically illustrates actuators for exciting degrees of freedom of movement of the scanning units according to FIGS. 1-4.

FIG. 7 schematically illustrates actuators for exciting degrees of freedom of movement of the scanning units according to FIGS. 1-4.

FIG. 8 schematically illustrates the course of time of the movement of actuators of a pair of actuators for exciting degrees of freedom of movement of the scanning units according to various examples.

FIG. 9 schematically illustrates the course of time of the movement of actuators of a pair of actuators for exciting degrees of freedom of movement of the scanning units according to various examples.

FIG. 10 schematically illustrates the resonant exciting of a degree of freedom of movement according to various examples.

FIG. 11 schematically illustrates a degree of freedom of movement corresponding, according to various examples, to torsion of elastic elements.

FIGS. 12 and 13 schematically illustrate a degree of freedom of movement corresponding, according to various examples, to a transverse deflection of elastic elements.

FIG. 14 schematically illustrates the superposed and resonant exciting of two degrees of freedom of motion according to various examples.

FIG. 15 schematically illustrates a scanning unit according to various examples.

FIG. 16 schematically illustrates a scanner with two scanning units according to various examples.

FIG. 17 schematically illustrates a scanner with two scanning units according to various examples.

FIG. 18 schematically illustrates a scanner with two scanning units according to various examples.

FIG. 19 schematically illustrates a scanner with two scanning units according to various examples.

FIG. 20 schematically illustrates a scanner with two scanning units according to various examples.

FIG. 21 schematically illustrates a scanner with two scanning units according to various examples.

FIG. 22 schematically illustrates a scanner with two scanning units according to various examples.

FIG. 23 schematically illustrates the course of time of an actuator movement provided by actuators according to various examples for exciting degrees of freedom of movement of the scanning units.

FIG. 24 schematically illustrates the amplitude of the movement according to a degree of freedom of movement achieved by the course of time of the actuator movement according to the example of FIG. 23.

FIG. 25 schematically illustrates the course of time of an actuator movement provided by actuators according to various examples for exciting degrees of freedom of movement of the scanning units.

FIG. 26 schematically illustrates the amplitude of the movement according to a degree of freedom of movement achieved by the course of time of the actuator movement according to the example of FIG. 25.

FIG. 27 schematically illustrates a superposition figure which is implemented by temporally superposing the movements according to the examples of FIGS. 24 and 26 by a scanner according to various examples.

FIG. 28 schematically illustrates a scanning unit with a magnet and an angular magnetic field sensor according to various examples.

FIG. 29 schematically illustrates an orientation of magnetization of the magnet according to the example of FIG. 28 upon torsion of an elastic element of the scanning unit.

FIG. 30 schematically illustrates a LIDAR system according to various examples.

FIG. 31 schematically illustrates a LIDAR system according to various examples.

FIG. 32 is a flowchart of an example method.

### DETAILED DESCRIPTION OF EMBODIMENTS

The above-described characteristics, features, and advantages of this invention, as well as the manner in which they will be achieved, will become clearer and more clearly understood in conjunction with the following description of the exemplary embodiments, which will be described in detail in conjunction with the drawings.

Hereinafter, the present invention will be described in more detail with reference to preferred embodiments with reference to the drawings. In the figures, like reference characters designate the same or similar elements. The figures are schematic representations of various embodiments of the invention. Elements shown in the figures are not necessarily drawn to scale. Rather, the various elements shown in the figures are reproduced in such a way that their function and general purpose will be understood by those skilled in the art. Connections and couplings between functional units and elements illustrated in the figures may also be implemented as an indirect connection or coupling. Functional units can be implemented as hardware, software or a combination of hardware and software.

Hereinafter, various techniques for scanning light will be described. For example, the techniques described below may allow 2-D scanning of light. Scanning may refer to repeated emission of the light at different radiation angles. For this purpose, the light can be deflected by a deflection once or more times.

The deflection unit can be formed, for example, by a mirror and optionally by an interface element which fixes the mirror to an elastic element. The deflection unit could also comprise a prism instead of the mirror.

The scanning may refer to the repeated sampling of different points in the surroundings by means of the light. For this purpose, different radiation angles can be implemented sequentially. The sequence of radiation angles can be determined by a superposition figure, if, for example, two degrees of freedom of movement are used temporally and optionally spatially superposed for scanning. For example, the amount of different points in the surroundings and/or the amount of different radiation angles may define a scan area. In various examples, the scanning of light may take place by the temporal superposition and optionally a spatial superposition of two movements corresponding to different degrees of freedom of at least one elastic mounting. Then a 2-D scan area is obtained.

Sometimes the superposition figure is also referred to as a Lissajous figure. The superposition figure can describe a sequence with which different radiation angles are realized by the movement of the support element.

In various examples, it is possible to scan laser light. In this case, for example, coherent or incoherent laser light can be used. It would be possible to use polarized or unpolarized laser light. For example, it would be possible to use pulsed laser light. For example, short laser pulses with pulse widths in the range of femtoseconds or picoseconds or nanoseconds can be used. For example, a pulse duration can be in the range of 0.5-3 nanoseconds. The laser light may have a wavelength in the range of 700-1800 nm. For the sake of simplicity, reference will be made hereinafter primarily to laser light; however, the various examples described herein may also be used to scan light from other light sources, for example broadband light sources or RGB light sources. RGB light sources herein generally refer to light sources in the visible spectrum, the color space being covered by superposing several different colors, such as red, green, blue or cyan, magenta, yellow, black.

In various examples, at least one support element will be used to scan light having a shape and/or material induced elasticity. Therefore, the at least one support element could also be referred to as a spring element or elastic mounting. The support element has a movable end. Then, at least one degree of freedom of movement of the at least one support element can be excited, for example a torsion and/or a transverse deflection. For this purpose different orders of transverse modes can be excited. By such an excitation of a movement, a deflection unit, which is connected to the movable end of the at least one support element, can be moved. Thus, the movable end of the at least one support element defines an interface element.

For example, it would be possible to use more than a single support element, e. g., two or three or four support elements. These support elements may optionally be arranged symmetrically with respect to each other.

In various examples, a movable end of one or more fibers is used as a support element for scanning the laser light: this means that the at least one support element can be formed by one or more fibers. Different fibers can be used as support elements. For example, optical fibers may be used, which are also referred to as glass fibers. However, in this case it is not necessary that the fibers are made of glass. The fibers may be made of plastic, glass or other material, for example. For example, the fibers may be made of quartz glass. The fibers may, for example, have a length in the range of 3 mm-10 mm, optionally in the range of 3.8 mm-7.5 mm. For example, the fibers may have a 70 GPa modulus of elasticity. This means that the fibers can be elastic. For example, the fibers can allow up to 4% material expansion. In some examples, the fibers have a core in which the injected laser light is propagated and trapped at the edges by total reflection (optical fibers). The fiber does not have to have a core. In various examples, so-called single mode fibers or multimode fibers may be used. The various fibers described herein may, for example, have a circular cross-section. For example, it would be possible for the various fibers described herein to have a diameter not smaller than 50 μm, optionally not <150 μm, further optionally not <500 μm, further optionally not <1 mm. For example, the various fibers described herein may be bendable, i. e., flexible. For this purpose, the material of the fibers described herein may have some elasticity. The fibers may have a core. The fibers may have a protective coating. In some examples, the protective coating may be at least partially removed, e. g. at the ends of the fibers.

In other examples, it would also be possible for elongate elements to be produced by means of MEMS techniques, i. e. to be produced by means of suitable lithographic process steps, for example by etching from a wafer.

For example, the movable end of the support element could be moved in one or two dimensions, with temporal and spatial superposition of two degrees of freedom of movement. One or more actuators can be used for this purpose. For example, it would be possible that the movable end is tilted relative to a fixing of the at least one support element; this results in a curvature of the at least one support element. This may correspond to a first degree of freedom of movement; this first degree of freedom of movement can be referred to as transverse mode (or sometimes as wiggle mode). Alternatively or additionally, it would be possible for the movable end to be twisted along a longitudinal axis of the support element (torsional mode). This may correspond to a second degree of freedom of movement. By moving the movable end it can be achieved that laser light is emitted at different angles. For this purpose, a deflection unit, such as a mirror optionally with a suitable interface for fixing, can be provided. This allows the surroundings to be scanned with the laser light. Depending on the intensity of movement of the movable end, scan areas of different sizes can be implemented.

In each of the various examples described herein, it is possible to excite the torsional mode alternatively or in addition to the transverse mode, i. e. temporal and spatial superposition of the torsional mode and the transverse mode would be possible. This temporal and spatial superposition can also be suppressed. In other examples, other degrees of freedom of motion could also be implemented.

For example, the deflection unit may comprise a prism or a mirror. For example, the mirror could be implemented by a wafer, such as a silicon wafer, or a glass substrate. For example, the mirror could have a thickness in the range of 0.05 μm-0.1 mm. For example, the mirror could have a thickness of 25 μm or 50 μm. For example, the mirror could have a thickness in the range of 25 μm to 75 μm. For example, the mirror could be square, rectangular or circular. For example, the mirror could have a diameter of 3 mm to 12 mm, or in particular 8 mm.

In general, such techniques can be used to scan light in a wide variety of applications. Examples include endoscopes and RGB projectors and printers and laser scanning microscopes. In various examples, LIDAR techniques can be used. The LIDAR techniques can be used to perform a spatially resolved distance measurement of environmental objects. For example, the LIDAR technique may include transit time measurements of the laser light between the mirror, the object, and a detector. In general, such techniques can be used to scan light in a wide variety of applications. Examples include endoscopes and RGB projectors and printers. In various examples, LIDAR techniques can be used. The LIDAR techniques can be used to perform a spatially resolved distance measurement of environmental objects. For example, the LIDAR technique may include transit time measurements of the laser light.

Various examples are based on the finding that it may be desirable to carry out the scanning of the laser light with a high accuracy with respect to the radiation angle. For example, in the context of LIDAR techniques, spatial resolution of the distance measurement may be limited by inaccuracy of the radiation angle. Typically, a higher (lower) spatial resolution is achieved the more accurate (less accurate) the radiation angle of the laser light can be determined.

Various examples are further based on the finding that it may be desirable to implement scanning of the laser light for a 2-D scan area. Often, for this purpose, it may be desirable to implement the 2-D scan area by the temporal superposition of two degrees of freedom of motion and a corresponding superposition figure. The various examples described herein make it possible to implement a high-resolution two-dimensional scan area with high accuracy, with the corresponding scanner allowing comparatively large integration into a small installation space.

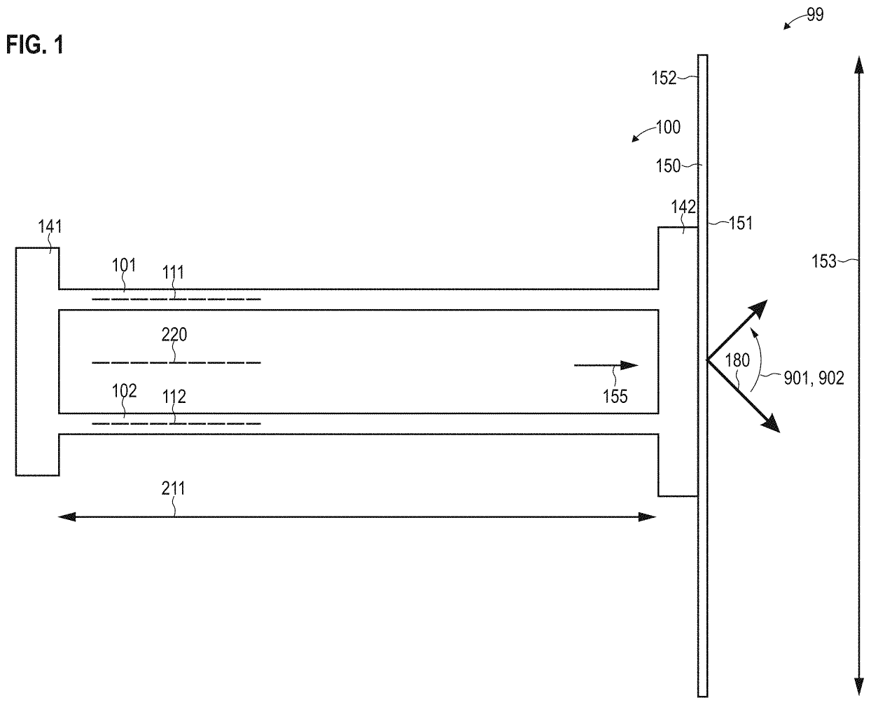

FIG. 1 illustrates aspects relating to a scanning unit 99. Scanning unit 99 comprises a scan module 100. Scan module 100 comprises a base 141, two support elements 101, 102, and an interface element 142. Support elements 101, 102 are formed in a plane (drawing plane of FIG. 1). Scan module 100 may also be referred to as an elastic mounting.

In this case, base 141, support elements 101, 102, and interface element 142 are integrally formed. For example, it would be possible for base 141, support elements 101, 102, and interface element 142 to be obtained by MEMS processes by etching a silicon wafer (or other semiconductor substrate). In such a case, base 141, support elements 101, 102, as well as interface element 142 may be formed in particular monocrystalline. However, in other examples, base 141, support elements 101, 102, as well as interface element 142 could not be integrally formed; for example, the support elements could be implemented by fibers.

It would also be possible for scan module 100 to have only a single support element or to have more than two support elements.

Scanning unit 99 also comprises a mirror 150 implementing a deflection unit. In the example of FIG. 1, the mirror 150 forming a mirror surface 151 with high reflectivity (for example greater than 95% at a wavelength of 950 μm, optionally >99%, further optionally >99.999%; e. g. aluminum or gold at a thickness of 80-250 nm) on the front side for light 180, is not integrally formed with base 141, support elements 101, 102, and interface element 142. For example, mirror 150 could be glued to interface element 142. Namely, interface element 142 may be configured to fix mirror 150 and the mirror surface 151, respectively. For example, for this purpose, interface element 142 could have an abutment surface configured to fix a corresponding abutment surface of mirror 150. For example, to join mirror 150 and interface element 142, one or more of the following techniques could be used: gluing; soldering. The mirror also has a rear side 152.

By means of such techniques large mirror surfaces can be realized, e. g. not smaller than 10 mm², optionally not smaller than 15 mm². As a result, high accuracy and range can be achieved in connection with LIDAR techniques that use the mirror surface 151 also as a detector aperture.

In the example of FIG. 1, scan module 100 extends away from rear side 152 of mirror 150, i. e., on a side of mirror 150 facing rear side 152. Thereby, a 1-point mounting of the mirror is implemented.

In the example of FIG. 1, support elements 101, 102 have an extension perpendicular to mirror surface 151; this extension could be, for example, about 2 to 8 mm, in the example of FIG. 1. Support elements 101, 102 are in particular rod-shaped along corresponding longitudinal axes 111, 112. In FIG. 1, surface normal 155 of mirror surface 151 is shown; longitudinal axes 111, 112 are oriented parallel to surface normal 155, i. e. they form an angle of 0°.

Therefore, the extension of support elements 101, 102 perpendicular to mirror surface 151 is equal to length 211 of support elements 101, 102. In general, it would be possible that length 211 of support elements 101, 102 is not shorter than 2 mm, optionally not shorter than 4 mm, further optionally not shorter than 6 mm. For example, it would be possible that the length of support elements 101, 102 is not greater than 20 mm, optionally not greater than 12 mm, further optionally not greater than 7 mm. If multiple support elements are used, they can all be the same length.

In general, length 211 of support elements 101, 102 may be in the range of 20%-400% of a diameter 153 of mirror 150. In general, length 211 could not be less than 20% of diameter 153, optionally not less than 200% of the diameter, further optionally not less than 400%. As a result, on the one hand a good stability can be provided, on the other hand comparatively large scan areas can be implemented.

However, depending on the relative orientation of longitudinal axes 111, 112 with respect to mirror surface 151, it would be possible for the extension of support elements 101, 102 perpendicular to mirror surface 151 to be shorter than their length 211 (because only the projection parallel to surface normal 155 is considered). In general, it would be possible that the extension of support elements 101, 102 perpendicular to mirror surface 151 is not smaller than 0.7 mm. Such a value is larger than the typical thickness of a wafer from which the scan module 100 can be made. As a result, particularly large scanning angles for light 180 can be implemented.

The material of support elements 101, 102 may effect a material-induced elasticity of support elements 101, 102. Furthermore, the elongated, rod-like shape of support elements 101, 102 may also effect a shape-induced elasticity of support elements 101, 102. By means of such an elasticity of support elements 101, 102, an elastic deformation to a movement of interface element 142 and thus also of mirror 150 can be achieved. For example, a torsional mode and/or a transverse mode of support elements 101, 102 could be used to move interface element 142—and thus mirror 150. As a result, the scanning of light can be implemented (in FIG. 1, the idle state of support elements 101, 102 is shown).

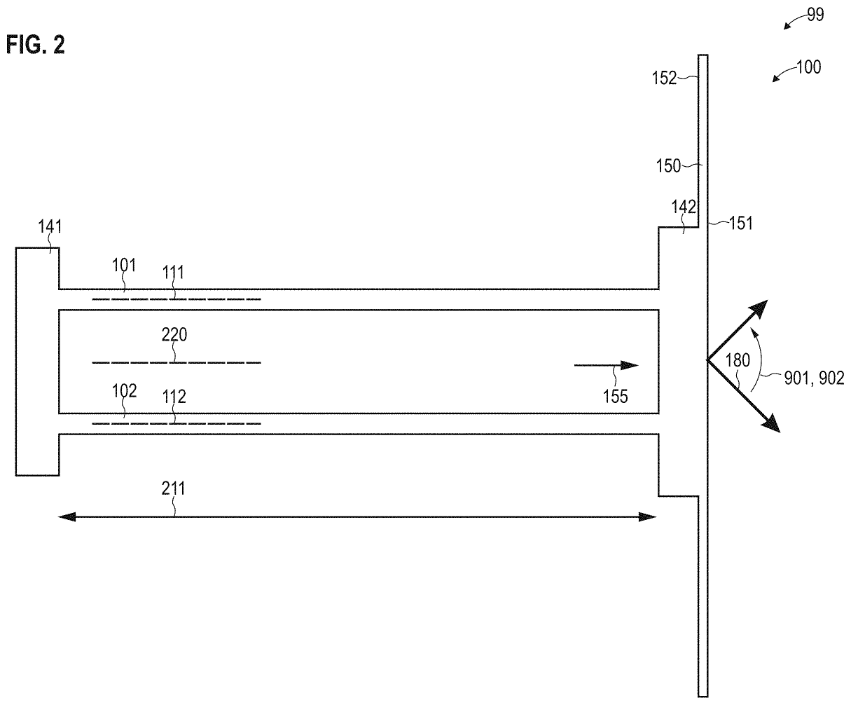

FIG. 2 illustrates aspects relating to a scan module 100. Scan module 100 comprises a base 141, two support elements 101, 102, and an interface element 142. In this case, base 141, support elements 101, 102, and interface element 142 are integrally formed.

The example of FIG. 2 basically corresponds to the example of FIG. 1. However, in the example of FIG. 2, mirror 150 is formed integrally with interface element 142 or support elements 101, 102, and base 141. In order to achieve the largest possible mirror surface 151, in the example of FIG. 2, a projection is provided over a central area of interface element 142.

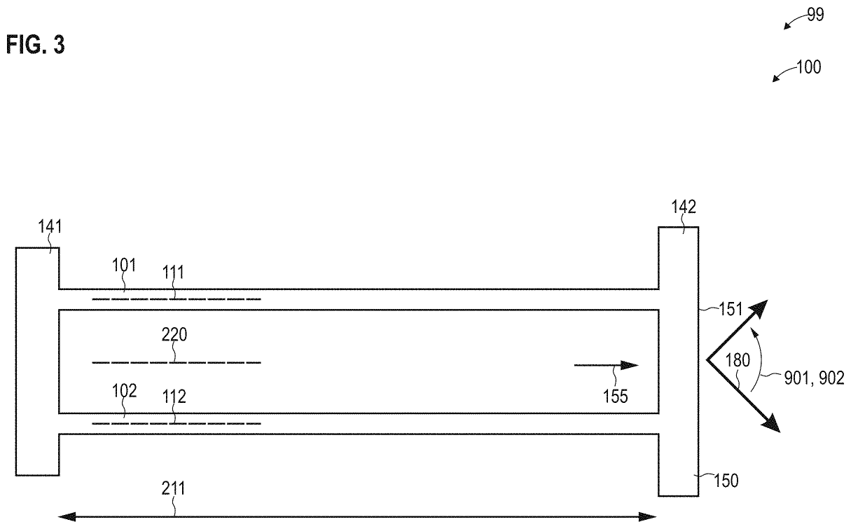

FIG. 3 illustrates aspects relating to a scan module 100. Scan module 100 comprises a base 141, two support elements 101, 102, and an interface element 142. Base 141, support elements 101, 102, and interface element 142 are integrally formed.

The example of FIG. 3 basically corresponds to the example of FIG. 2. In the example of FIG. 3, mirror 150 and interface element 142 are implemented by one and the same element. Mirror surface 151 implementing the deflection unit is applied directly to interface element 142. This allows a particularly simple structure and a simple production.

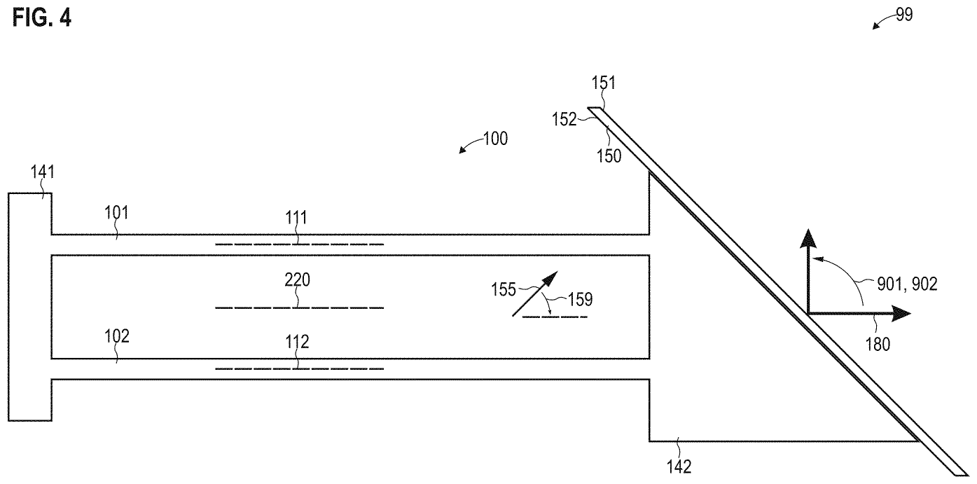

FIG. 4 illustrates aspects relating to a scan module 100. Scan module 100 comprises a base 141, two support elements 101, 102, and an interface element 142. Base 141, support elements 101, 102, and interface element 142 are integrally formed.

The example of FIG. 4 basically corresponds to the example of FIG. 1. In the example of FIG. 4, however, the longitudinal axes 111, 112 of support elements 101, 102 are not oriented perpendicular to mirror surface 151. In FIG. 4, angle 159 between surface normal 155 of mirror surface 151 and longitudinal axes 111, 112 is shown. In the example of FIG. 4, angle 159 is 45°, but could generally be in the range of −60° to +60°.

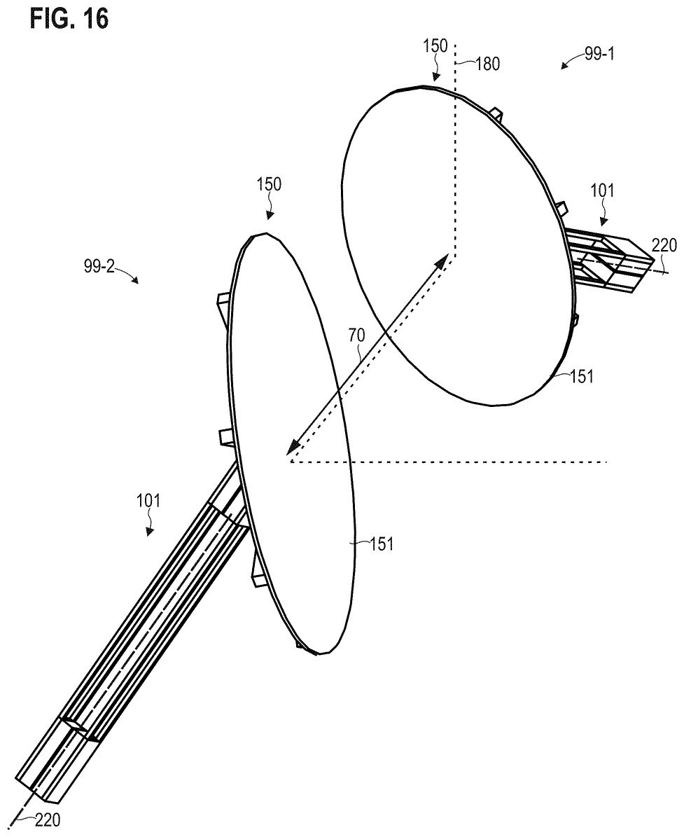

Such tilting of mirror surface 151 with respect to longitudinal axes 111, 112 may be advantageous, in particular, if the torsional mode of support elements 101, 102 is used to move mirror 150. Then, periscope-like scanning of light 180 may be implemented by scanning unit 99. By said periscope-like scanning it can be avoided that the aperture—that is, in some examples, when the light is emitted and received via same mirrors 150, in particular, the detector aperture—for a single mirror 150 is dependent on the scan angle. In the case of two sequential mirrors 150 (cf., FIG. 16 et seq.) when using two scanning units (in FIG. 16: 99-1, 99-2) the aperture is dependent on the scan angle indeed, with smaller apertures being obtained for larger scan angles and larger distances between mirrors 150. Overall, however, this dependence—due to the periscope-like scanning of an individual mirror 150—is lower than in comparable systems of the prior art in which even a single mirror 150 is scanned in such a way that the aperture varies as a function of the scan angle. In particular, the periscope-like scanning does not tilt mirror surface 151 of first mirror 150 of a first scanning unit relative to mirror surface 150 of second mirror 150 of a second scanning unit.

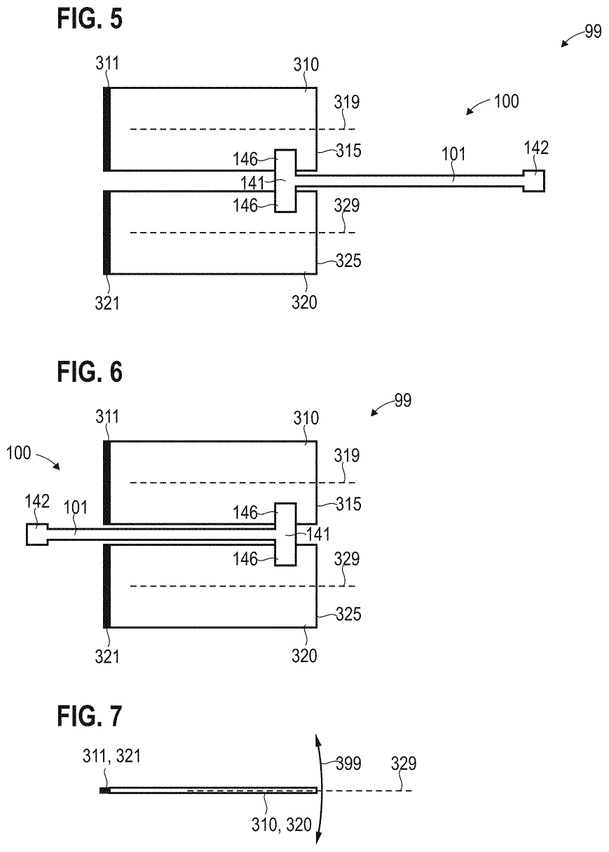

FIG. 5 illustrates aspects relating to a scanning unit 99. Scanning unit 99 comprises scan module 100 which could be configured, for example, according to the various other examples described herein (however, FIG. 5A exemplifies a scan module 100 having only a single support element 101).

FIG. 5 particularly illustrates aspects relating to piezo actuators 310, 320. In various examples, piezoelectric bending actuators 310, 320 may be used to excite support element 101. Piezo actuators 310, 320 can be controlled, for example, by a suitable controller—for example via a driver.

For example, generally a first and a second piezoelectric bending actuator may be used. It would be possible for the first piezoelectric bending actuator and/or the second piezoelectric bending actuator to be plate-shaped. In general, a thickness of the piezoelectric bending actuators can be, for example, in the range from 200 μm to 1 mm, optionally in the range from 300 μm to 700 μm. For example, it would be possible for the first piezoelectric bending actuator and/or the second piezoelectric bending actuator to have a layer structure comprising an alternating arrangement of a plurality of piezoelectric materials. These materials can have a piezoelectric effect of different magnitude. As a result, a bending can be effected with temperature changes, similar to a bimetallic strip. For example, it is possible for the first piezoelectric bending actuator and/or the second piezoelectric bending actuator to be fixed at a fixing point: an end opposite the fixing point can then be moved due to a bending or curvature of the first piezoelectric bending actuator and/or the second piezoelectric bending actuator.

By the use of piezoelectric bending actuators a particularly efficient and strong excitation can be achieved. Namely, the piezoelectric bending actuators can move base 141 and, in particular, tilt it—for exciting a torsional mode of the at least one support element. In addition, it may be possible to achieve high integration of the device for excitation. This can mean that the required installation space can be dimensioned particularly small.

In particular in the example of FIG. 5, piezo actuators 310, 320 are designed as piezoelectric bending actuator. This means that applying a voltage to electrical contacts of piezoelectric bending actuators 310, 320 effects a curvature or bending of the piezoelectric bending actuators 310, 320 along their longitudinal axes 319, 329. For this purpose, piezoelectric bending actuators 310, 320 have a layer structure (not illustrated in FIG. 5 and oriented perpendicular to the drawing plane). In this way, one end 315, 325 of piezoelectric bending actuators 310, 320 is deflected perpendicular to respective longitudinal axes 319, 329 with respect to a fixing point 311, 321 (the movement is oriented perpendicular to the drawing plane in the example of FIG. 5). Movement 399 of piezoelectric bending actuators 310, 320 (actuator movement) due to the bending is shown in FIG. 6.

FIG. 7 is a side view of piezoelectric bending actuators 310, 320. FIG. 7 shows piezoelectric bending actuators 310, 320 in anidle position of scanning unit 99, for example without a driver signal or tension/curvature.

Referring again to FIG. 5: For example, the fixing point in 311, 321 could establish a rigid connection between piezoelectric bending actuators 310, 320 and a housing of scanning unit 99 (not shown in FIG. 5) and be arranged stationarily in a reference coordinate system.

Base 141 could have a longitudinal extent of longitudinal axes 319, 329 that is in the range of 2 to 20% of the length of piezoelectric bending actuators 310, 320 along longitudinal axes 319, 329, optionally in the range of 5 to 15%. As a result, excitation of sufficient magnitude can be achieved; base 141 attenuates the movement of piezoelectric bending actuators 310, 320 only comparatively weakly.

In the example of FIG. 5, piezoelectric bending actuators 310, 320 are arranged substantially parallel to each other. Tilting of the longitudinal axes 319, 329 relative to each other would be possible, too, especially as long as they are in one plane.

From the example of FIG. 5, it can be seen that the connection of piezoelectric bending actuators 310, 320 with the support element 101 is implemented via edge regions 146 of base 141. Because these edge regions 146 have elasticity, flexure 399 can be received and results in deflection of base 141. This allows one or more degrees of freedom of movement of interface element 101 coupled via base 141 to be excited. This results in a particularly efficient and space-saving excitation.

In the example of FIG. 5, piezoelectric bending actuators 310, 320 extend away from interface element 142. However, it would also be possible for piezoelectric bending actuators 310, 320 to extend along at least 50% of their length toward interface element 142. As a result, a particularly compact arrangement can be achieved. This is shown in FIG. 6.

The example of FIG. 6 basically corresponds to the example of FIG. 6. However, piezoelectric bending actuators 310, 320 extend toward the interface element 142 or toward a freely movable end of the at least one support element 101. In this way, a particularly compact design of scanning unit 99 can be achieved.

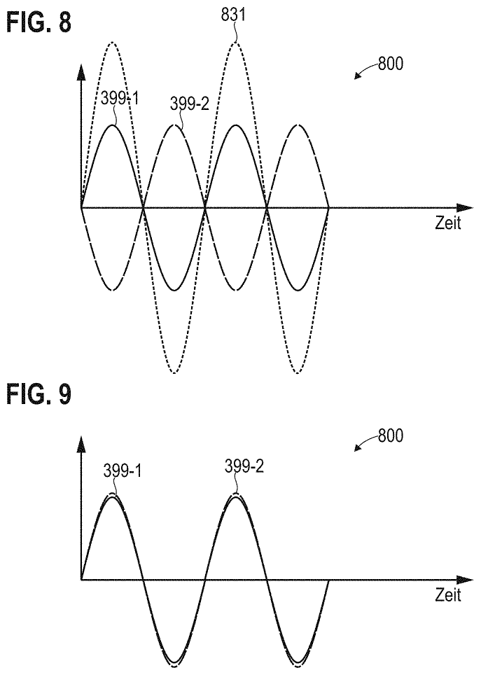

FIG. 8 schematically illustrates aspects relating to a movement 399-1, 399-2 of piezoelectric bending actuators 310, 320. Through a corresponding movement 399-1, 399-2, a flow of force can be transmitted to support elements 101, 102, so that one or more degrees of freedom of movement can be excited.

In other examples, other types of actuators may be used. For example, it would be possible to use actuators which transmit an excitation without contact by means of a magnetic field. Then, a flow of force corresponding to movement 399-1, 399-2 can also be implemented differently.

In the example of FIG. 8, a sine-shaped movement 399-1, 399-2 of piezoelectric bending actuators 310, 320 occurs, with 180° phase offset between movements 399-1, 399-2 (solid and dashed lines in FIG. 8). As a result, base 141 is tilted (for example with respect to the drawing plane of FIGS. 1-4), whereby a torsional mode can be excited particularly efficiently.

In FIG. 8, relative actuator movement 831 is also shown as the offset or distance in the direction of movement 399-1, 399-2 between ends 315, 325 of piezoelectric bending actuators 310, 320 due to movements 399-1, 399-2 (dotted line in FIG. 8).

FIG. 9 schematically illustrates aspects relating to a movement 399-1, 399-2 of piezoelectric bending actuators 310, 320. Through a corresponding movement 390-1, 399-2, a flow of force can be transmitted to support elements 101, 102, so that one or more degrees of freedom of movement can be excited.

The example of FIG. 9 basically corresponds to the example of FIG. 8, wherein there is no phase offset between movements 399-1, 399-2. This results in an up and down movement of base 141 (for example, with respect to the drawing plane of FIGS. 1-4), whereby a transverse mode can be excited particularly efficiently.

In FIG. 9, actuator movement 831 is equal to 0.

In some examples, it would be possible for the movement of piezoelectric bending actuators 310, 320—or a differently designed flow of force of a suitable actuator—to excite a temporal and spatial superposition of multiple degrees of freedom of movement. This can take place, for example, by superposing the movements 399-1, 399-2 according to the examples of FIGS. 8 and 9. Thus, a superposition of the in-phase and out-of-phase movements 399-1, 399-2 can be used.

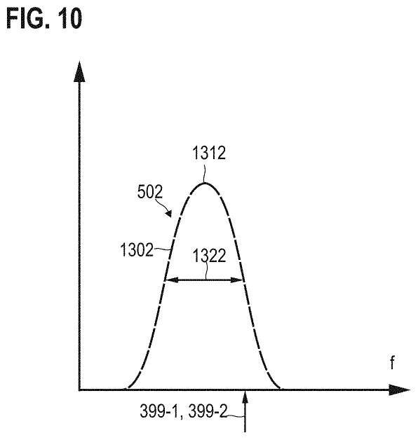

FIG. 10 schematically illustrates aspects relating to a movement 399-1, 399-2 of piezoelectric bending actuators 310, 320. In particular, FIG. 10 illustrates movement 399-1, 393-2 in frequency space. FIG. 10 illustrates a frequency of movement 399-1, 399-2 with respect to a resonance curve 1302 of a torsional mode 502. Resonance curve 1302 is characterized by a peak width at half-height 1322 and a maximum 1312. In the example of FIG. 10, a resonant excitation takes place because the frequency of movement 399-1, 399-2 is located within resonance curve 1302.

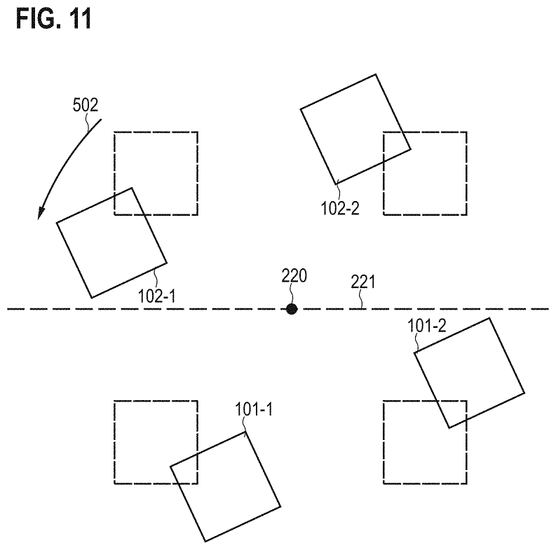

FIG. 11 illustrates aspects relating to torsional mode 502. FIG. 11 schematically illustrates the deflection of torsional mode 502 for a scanning unit 99 with four supporting elements 101-1, 101-2, 102-1, 102-2 (in FIG. 11, the deflected state is shown by the solid lines and the idle state with the dashed lines).

In FIG. 11, the torsion axis of torsional mode 220 is congruent with central axis 220 or parallel to the axes of support elements 101-1, 101-2, 102-1, 102-2. In the example of FIG. 11, support elements 101-1, 102-1, 101-2, 102-2 are configured rotationally symmetrical with respect to a central axis 220. In particular, there is a four-fold rotational symmetry. The presence of a rotational symmetry means, for example, that the system of support elements 101-1, 102-1, 101-2, 102-2 can be converted into itself by rotation. The degree of rotational symmetry designates how often per 360° rotation angle the system of support elements 101-1, 102-1, 101-2, 102-2 can be converted into itself. In general, the rotational symmetry could be n-fold, wherein n denotes the number of supporting elements used.

Due to the arrangement with a high degree of rotational symmetry, the following effect can be achieved: Nonlinearities in the excitation of torsional mode 502 can be reduced or suppressed. This can be made plausible by the following example: for example, support elements 101-1, 102-1, 101-2, 102-2 could be arranged such that the longitudinal axes and central axis 220 all lie in one plane. Then, there would be a two-fold rotational symmetry (and not four-fold as in the example of FIG. 11). In such a case, the orthogonal transverse modes (different directions perpendicular to central axis 220) have different frequencies—due to different moments of inertia. Thus, for example, the direction of the low-frequency transverse mode rotates together with the rotation upon excitation of torsional mode 502. As a result, a parametric oscillator is formed because the natural frequencies vary as a function of the angle of rotation or thus as a function of time. The transfer of energy between the various states of the parametric oscillator causes nonlinearities. By using a high degree of rotational symmetry, the formation of the parametric oscillator can be prevented. Preferably, the support elements can be arranged so that the natural frequencies are not dependent on the torsion angle.

By avoiding nonlinearities in the excitation of the torsional mode of support elements 101-1, 102-1, 101-2, 102-2, it can be achieved that particularly large scan angles of the light through torsional mode 502 can be achieved.

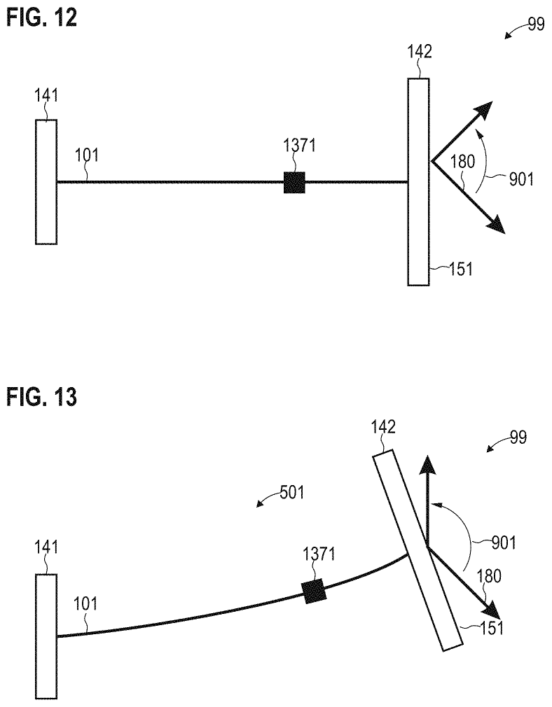

FIG. 12 illustrates aspects relating to a scanning unit 99. In the example of FIG. 12, scanning unit 99 comprises a single support element 101 with an optional balancing weight 1371. Therefore, upon excitation of transverse mode 501, a tilting of mirror surface 151 occurs. This is shown in FIG. 13. In FIG. 13, in particular, lowest order transverse mode 501 is shown. In other examples, it would also be possible to use a transverse mode of higher order to scan light 180, in which case the deflection of support element 101 at certain positions along length 211 of support element 101 would be zero (so-called node of the deflection).

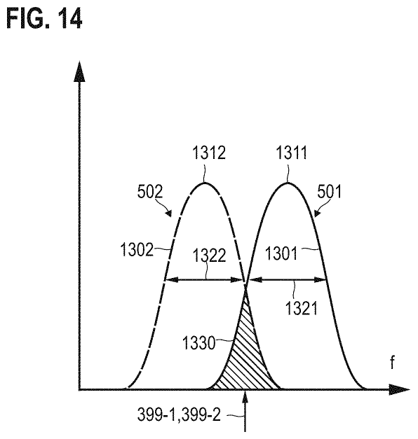

FIG. 14 illustrates aspects relating to resonant curves 1301, 1302 of degrees of freedom of movement 501, 502, by means of which, for example, a superposition figure for a 2-D scan area can be implemented. FIG. 14 illustrates the amplitude of the excitation of respective degree of freedom of movement 501, 502. A resonance spectrum according to the example of FIG. 14 may be desirable in particular if a temporal and spatial superposition of different degrees of freedom of movement 501, 502 of at least one support element 101, 102 is desired for the 2-D scanning.

In the example of FIG. 14, two resonance curves 1301, 1302 could be excited temporally and spatially, e. g., by using a single scanning unit 99 to implement different degrees of freedom of movement 501, 502. However, it would also be possible that in the example of FIG. 14, two resonance curves 1301, 1302 are excited when they are temporally superposed, but not spatially superposed. For this purpose, it would be possible to use a first scanning unit 99 to implement a degree of freedom of movement 501, 502 according to resonance curve 1301, and a second scanning unit 99 to implement a degree of freedom of movement 501, 502 according to resonance curve 1302,

Resonance curve 1301 of transverse mode 501 has a maximum 1311 (solid line). In FIG. 14, resonance curve 1302 of torsional mode 502 is also shown (dashed line). Resonance curve 1302 has a maximum 1312.

Maximum 1312 of torsional mode 502 is at a lower frequency than maximum 1311 of transverse mode 501, which could be, for example, lowest order transverse mode 501. In this way, it can be achieved that the scan module is particularly robust against external disturbances such as vibrations, etc. This is the case since such external excitations typically excite transverse mode 501 particularly efficiently, but do not excite torsional mode 502 particularly efficiently.

For example, resonance curves 1301, 1302 could be Lorentz-shaped. This would be the case if corresponding degrees of freedom of movement 501, 502 can be described by a harmonic oscillator.

There is a frequency shift among maxima 1311, 1312. For example, the frequency spacing between maxima 1311, 1312 could be in the range of 5 Hz to 500 Hz, optionally in the range from 10 Hz to 200 Hz, further optionally in the range from 30 Hz to 100 Hz.

In FIG. 14, peak widths at half-height 1321, 1322 of resonance curves 1301, 1302 are also shown. Typically, the peak width at half-height is defined by the attenuation of corresponding degree of freedom of movement 501, 502. In the example of FIG. 14, peak widths at half-height 1321, 1322 are equal; however, in general, peak widths at half-height 1321, 1322 could be different from each other.

In the example of FIG. 14, resonance curves 1301, 1302 have an overlap region 1330 (shown in dark). This means that transverse mode 501 and the torsional mode 502 are degenerate. In overlap region 1330, both resonance curve 1301 and resonance curve 1302 have significant amplitudes. For example, it would be possible for each of the amplitudes of resonance curves 1301, 1302 in the overlap region not to be smaller than 10% of the corresponding amplitudes at respective maximum 1311, 1312, optionally not <5% each, further optionally not <1% each. Due to overlap region 1330, it can be achieved that two degrees of freedom of movement 501, 502 can be excited in a coupled manner, namely in each case resonantly at the same frequency. The frequency is between two maxima 1311, 1312. Thus, the temporal and spatial superposition can be achieved. On the other hand, nonlinear effects can be suppressed or avoided by coupling between the two degrees of freedom of movement 501, 502.

Instead of using different degrees of freedom of movement 501, 502—in the example of FIG. 14, a torsional mode 502 and a transverse mode 501—a superposition figure could also be achieved by double use of the same degree of freedom of movement. For example, torsional mode 502 of a first scanning unit could be excited, as well as torsional mode 502 of a second scanning unit. Thus, there is no spatial superposition of the two torsional modes, which may rather be assigned to different scanning units 99. Alternatively, it would also be possible, for example, to excite transverse mode 501 of a first scanning unit, as well as transverse mode 501 of a second scanning unit. Even in such cases of double use of the same degree of freedom of movement in different scanning units mentioned above, a certain distance between the maxima of the resonance curves may result—for example, due to manufacturing tolerances or targeted structural variation between the scanning units, etc.

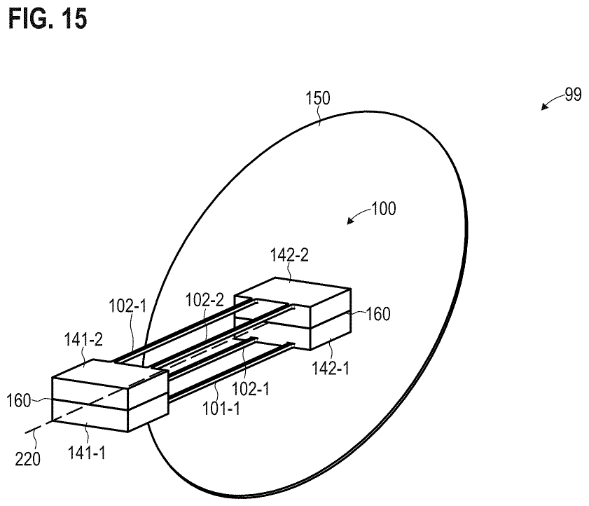

FIG. 15 illustrates aspects relating to a scanning unit 99. In the example of FIG. 15, a scan module 100 is shown which has a first pair of support elements 101-1, 102-1 and a second pair of support elements 102-1, 102-2. The first pair of support elements 101-1, 102-1 is arranged in a plane; the second pair of support elements 101-2, 102-2 is also arranged in a plane. These planes are parallel to each other and offset from one another.

In the example of FIG. 15, for example, two scan modules 100 according to the example of FIG. 4 may be combined. Each pair of support elements is associated with a corresponding base 141-1, 141-2, and a corresponding interface element 142-1, 142-2. Both interface elements 142-1, 142-2 establish a connection with a mirror 150 here. In this way it can be achieved that a particularly stable scan module 100 can be provided, which has a large number of supporting elements. In particular, scan module 100 may have support elements which are arranged in different planes. This can allow a particularly large robustness.

From FIG. 15, it can also be seen that base 141-1 is not integrally formed with base 141-2. In addition, interface element 142-1 is not formed integrally with interface element 142-2. Also, support elements 101-1, 102-1 are not formed integrally with support elements 102-1, 102-2. In particular, it would be possible for the various aforementioned parts to be manufactured from different sections of a wafer and then connected to one another, for example by gluing or anodic bonding. Other examples of joining techniques include: fusion bonding; fusion or direct bonding; eutectic bonding; thermocompression bonding; and adhesive bonding. Corresponding connection surfaces 160 are marked in FIG. 15. By means of such techniques it can be achieved that scan module 100 can be manufactured particularly easily. In particular, it is not necessary for complete scan module 100 to be manufactured in one piece or integrated from one wafer. Rather, scan module 100 can be produced in a two-stage manufacturing process. At the same time, however, this can not significantly reduce the robustness: due to large-area connection surfaces 160, a particularly stable connection between the base 141-1 and base 141-2, or interface element 142-1 and interface element 142-2 can be produced.

However, it is possible in this case that base 141-1, support elements 101-1, 102-1, and interface element 142-1 can be mapped to base 141-2, support elements 102-1, 102-2 and interface element 142-2 by mirroring on a plane of symmetry (in which also the connecting surfaces 160 are). As a result, a highly symmetrical structure can be achieved. In particular, a rotationally symmetrical structure can be achieved. The degree of rotational symmetry can be n=4; i. e. equal to the number of support elements 101-1, 101-2, 102-1, 102-2 used. Such a symmetrical structure with respect to central axis 220 may in particular have advantages with respect to the excitation of torsional mode 502. Nonlinearities can be avoided.

For example, a scanning unit 99 according to the example of FIG. 15 can be used for torsional mode 502 according to the example of FIG. 11.

FIG. 16 illustrates aspects relating to a scanner 90. Scanner 90 comprises two scanning units 99-1, 99-2, which are each formed according to the example of FIG. 15. Thus, scanner 90 is configured to deflect light 180 sequentially on the front sides of mirrors 150 of scanning units 99-1, 99-2 (in FIG. 16, the corresponding optical path is shown as a dotted line). FIG. 16 illustrates the scanner in an idle state, i. e. without actuation of scanning units 99-1, 99-2, for example by means of piezoelectric bending actuators 310, 320.

For example, it would be possible for the torsional modes 502 of two scan modules 101 of scanning units 99-1, 99-2 to be excited in order to implement different radiation angles according to a superposition figure defining a 2-D scan area. However, other degrees of freedom of movement could also be used.

From FIG. 16, it can be seen that the mountings of mirrors 150 of scanning units 99-1, 99-2 each comprise four elastic, rod-shaped elements 101-1, 101-2, 102-1, 102-2. Thus, scanning units 99-1, 99-2 are configured according to the example of FIG. 15. However, in other examples, it would also be possible for the mountings of mirrors 150 to have fewer or more rod-shaped elements (e. g., only one rod-shaped elastic element as shown in FIGS. 5 and 6, and 12 and 13).

From the example of FIG. 16, it can be seen that scan modules 100 of scanning units 99-1, 99-2 each extend in different directions away from the rear sides of mirrors 150. Rear mountings are implemented by scan modules 101. Scan modules 101 extend toward sides facing the rear sides of mirrors 150. There are no mountings in the mirror plane of mirrors 150 of scanning units 99-1, 99-2. By means of such a rear-side one-point mounting of mirrors 150, it can be achieved that mirrors 150 of scanning units 99-1, 99-2 can be placed particularly close to one another. By such a high integration of scanner 90, a small housing design can be achieved. This promotes the integration of scanner 90, for example in passenger vehicles or aircraft drones, etc. In addition, it can be achieved that an effective detector aperture—if reflected light is also detected by means of mirrors 150—is dimensioned particularly large. This is favored because at large mirrors and large angles of rotation in reference implementations significant shifts of the mirror edges take place. Thus, it may happen that the mirrors in reference implementations abut on mountings, whereby the maximum aperture, or angle is limited.

For example, FIG. 16 shows a distance 70 between a center of mirror surface 151 of scanning unit 99-1 and mirror surface 151 of scanning unit 99-2. This distance 70 can be dimensioned particularly small. For example, this distance 70 could not be greater than four times the diameter of mirror surface 151, optionally not more than three times the diameter, further optionally not more than 1.8 times the diameter.

In the example of FIG. 16, central axis 220 of scan module 100 is tilted at an angle of 45° with respect to surface normal 155 of mirror surface 151 (see FIG. 4). Therefore, it may be desirable to excite both a torsional mode 502 of scan module 100 of scanning unit 99-1 and a torsional mode 502 of scan module 100 of scanning unit 99-2. These may be degenerate, but different resonance frequencies or maxima of the resonance curve are possible.

In the example of FIG. 16 an angle between central axes 220 of scanning units 99-1, 99-2 is equal to 90°. These angles could also vary around 90°, for example 90°±25°. By such an arrangement, a particularly large scan area can be implemented.

For example, if transverse modes 501 are used to scan light, it may again be desirable that the central axis 220 of scanning units 99-1, 99-2 join at an angle of substantially 180° (not shown in FIG. 16), i. e. a face-to-face arrangement of scanning units 99-1, 99-2 is chosen.

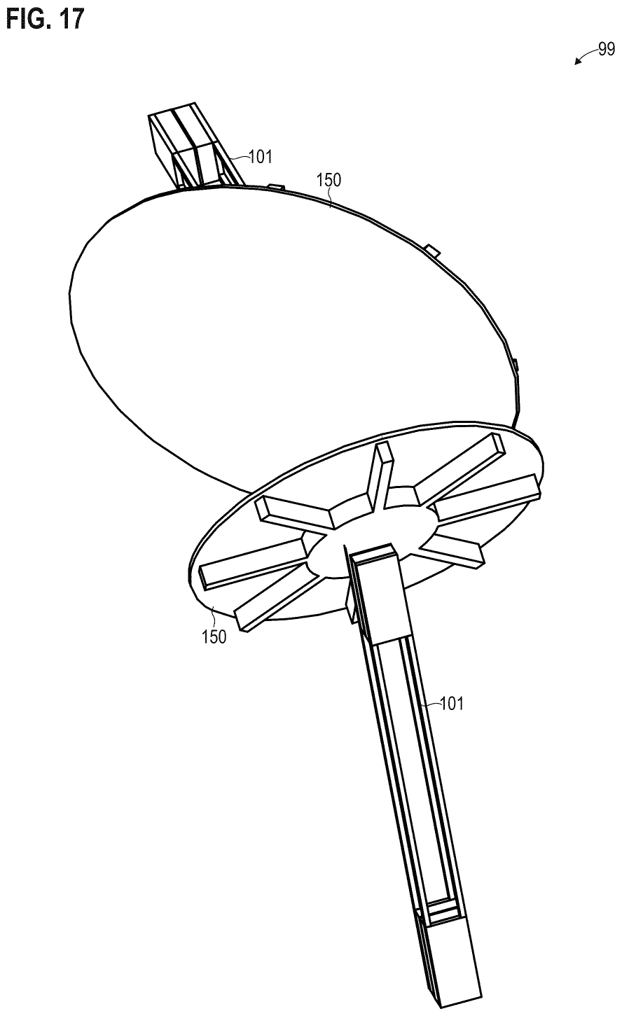

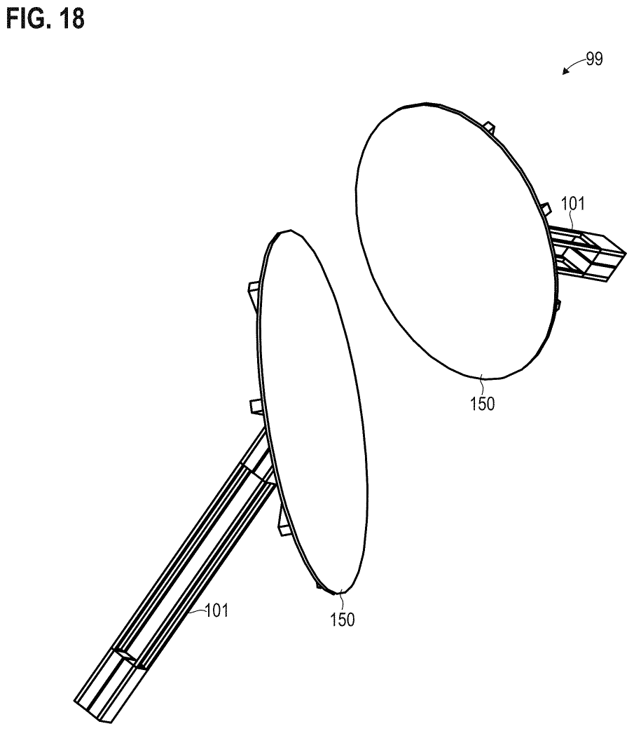

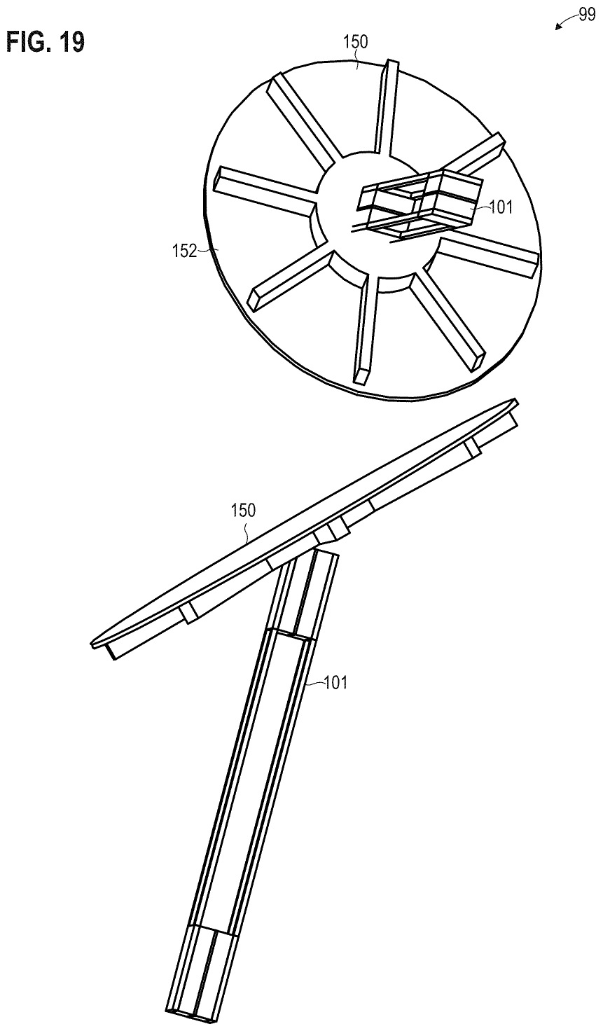

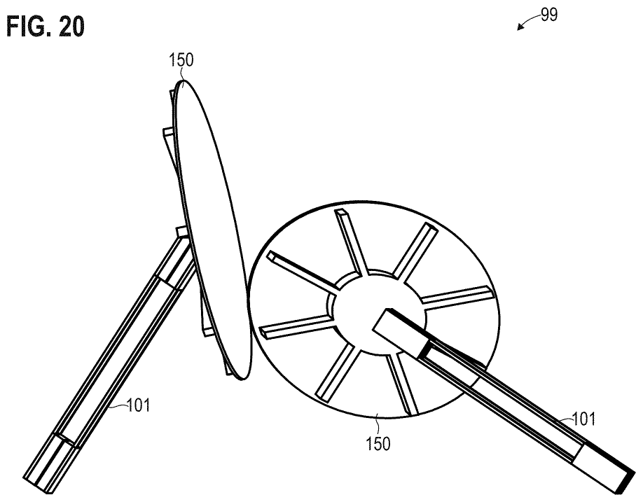

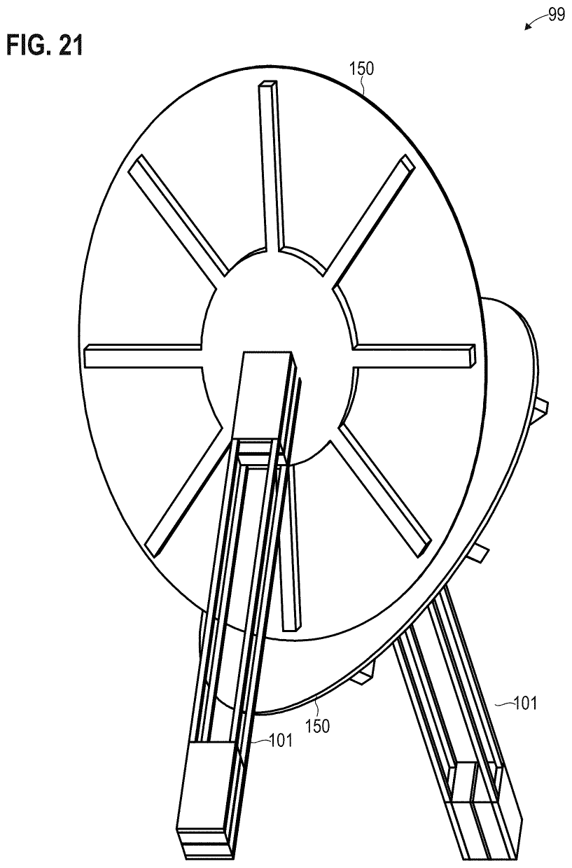

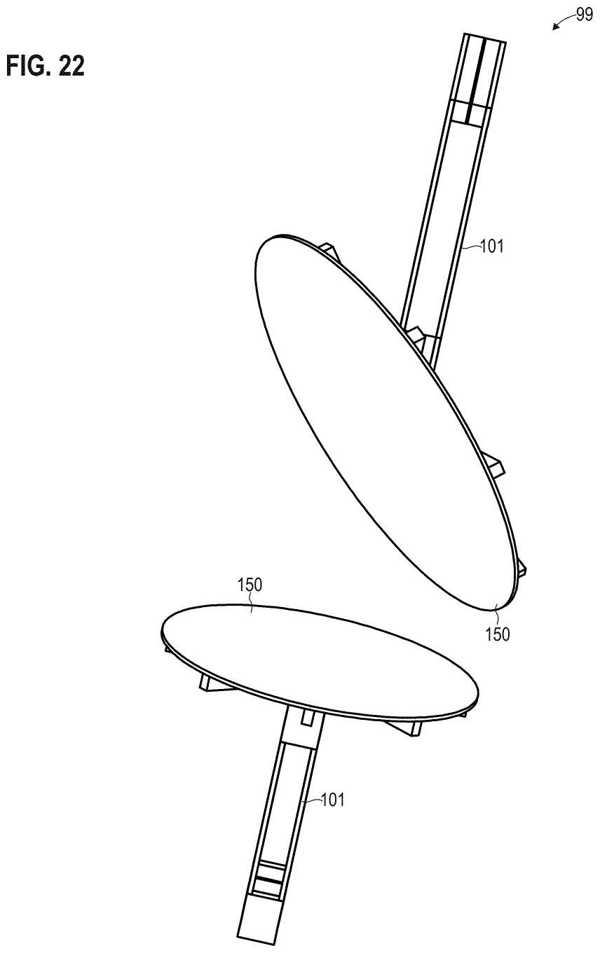

FIGS. 17-22 are different representations of scanner 90 according to the example of FIG. 16. Different perspectives are shown.

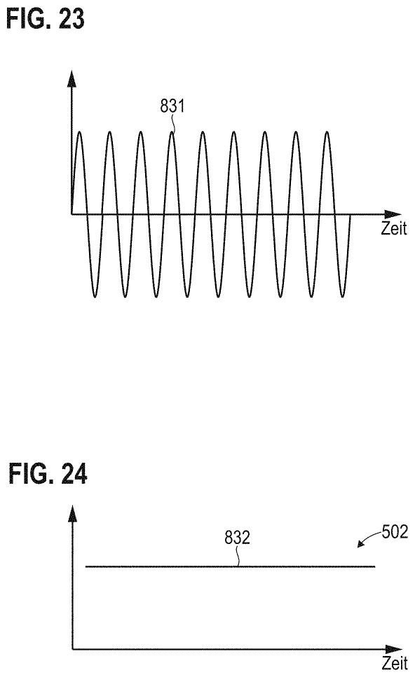

FIG. 23 illustrates aspects relating to the actuation of a scan module 100. For example, a scan module 100 of scanner 90 according to the examples of FIGS. 16-22 could be actuated accordingly.

FIG. 23 illustrates a course of time of the actuator movement 831. In FIG. 23, in particular, the relative deflection of piezoelectric bending actuators 310, 320 relative to each other is shown as actuator movement 831 (see FIG. 8). For example, FIG. 23 thus could illustrate a distance of ends 315, 325 of piezoelectric bending actuators 310, 320 of the examples of FIGS. 5 and 6. However, other parameters of actuator movement 831 could be considered also—for example, movement 399-1 of piezoelectric bending actuator 310 or movement 399-2 of piezoelectric bending actuators 399-2: The actuator movement 831 is proportional to a flow of force provided by piezoelectric bending actuators 310, 320. In that regard, FIG. 23 illustrates an example using piezoelectric bending actuators 310, 320; however, in other examples, other actuators, such as actuators that use magnetic fields, etc., could be used if a corresponding flow of force is provided.

The frequency of actuator movement 831 is tuned to resonance curve 1301, 1302 of the selected degree of freedom of movement 501, 502 (cf. FIGS. 10 and 14): The actuator movement excites a degree of freedom of movement 501, 502. In the example of FIG. 24, torsional mode 502 is excited because actuator movement 831 causes a tilting of base 141 of scan module 100. This is the case because actuator movement 831 causes a time-variable distance of ends 315, 325 of piezoelectric bending actuators 310, 320 to each other. In other examples, the transverse mode 501 could also be excited by a suitable actuator movement.

In the example of FIG. 23, actuator movement 831 has a constant amplitude. As a result, torsional mode 502 is excited with constant amplitude 832. This is shown in FIG. 24 (in FIG. 24, the instantaneous deflection of the torsional mode is not shown).

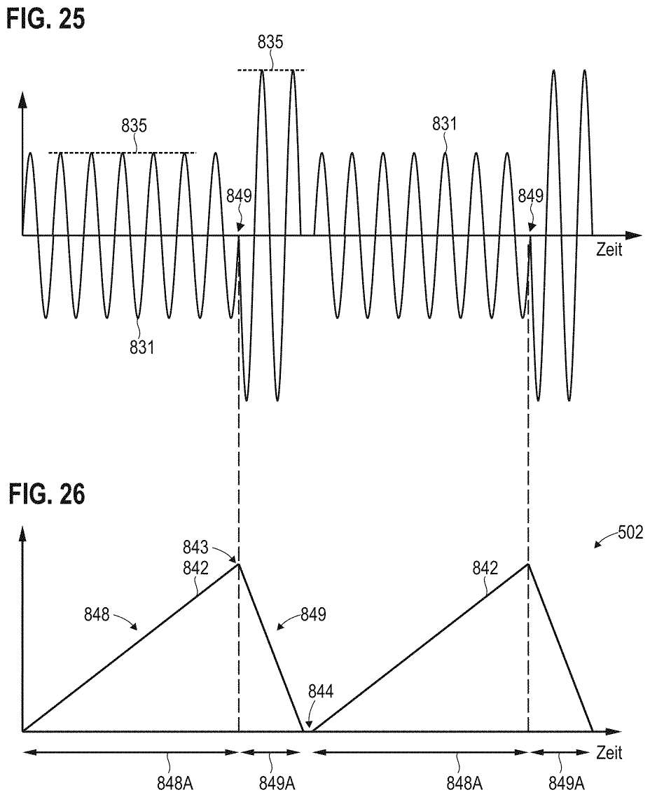

FIGS. 25 and 26 basically correspond to FIGS. 23 and 24. In the example of FIGS. 25 and 26, however, the piezoelectric bending actuators 310, 320 are configured to excite the torsional mode 502 according to a periodic amplitude modulation function 842 having alternately ascending flanks 848 and descending flanks 849. For this purpose, a suitable actuator movement 831 is implemented.

From FIG. 26 it can be seen, in particular, that length 848A of ascending flanks 848 is substantially greater than length 849A of descending flanks 849. For example, the length of ascending flanks 848 could be dimensioned to be at least twice as large as the length of descending flanks 849, optionally at least four times as large, further optionally at least ten times as large.

In the example of FIG. 25, descending flanks 849 are dimensioned so short that their lengths are not larger than two period durations of the frequency of the resonantly actuated torsional mode 502 or the frequency of actuator movement 831. In general the length of descending flanks 849 of amplitude modulation function 842 could be no larger than ten period durations of the frequency of torsional mode 502, optionally not larger than three period durations, further optionally not larger than two period durations.

Due to a particularly short dimensioning of length 849A of descending flanks 849, it can be achieved that scan module 100 can be converted into idle state 844 very quickly with respect to the corresponding degree of freedom of movement 501, 502 after actuation has taken place up to maximum amplitude 843 —whereupon another actuation can take place. This means that a reset of the movement according to the corresponding degree of freedom of movement 501, 502 can take place quickly. This may be particularly useful when implementing a superposition figure by means of the corresponding degree of freedom of movement.

For example, it would be possible for LIDAR imaging measurements to be performed only during ascending flanks 848. The amount of all LIDAR measurements recorded during period of time 848A can correspond to a LIDAR image for specific surrounding area. The same surrounding area can be scanned again after the reset so that LIDAR images are provided at a specific refresh frequency. The shorter length 849A, the higher the refresh frequency.

The short dimensioning of the length of descending flanks 849 may be achieved by slowing down the movement according to torsional mode 502 during descending flanks 849. In other words, this means that the movement according to torsional mode 502 is actively attenuated, i. e., attenuated more, than provided by an intrinsic attenuation or the mass moment of inertia. For this purpose, a suitable actuator movement 831 of the piezoelectric bending actuators 310, 320 can be used.

Such slowing down of the movement of torsional mode 502 is achieved in particular by increasing amplitude 835 of actuator movement 831 during descending flanks 849. This can be achieved, for example, by increasing individual movements 399-1, 399-2 of piezoelectric bending actuators 310, 320. For example, an average amplitude of actuator movement 831 during descending flanks 849 could be twice as large as an average amplitude of actuator movement 831 during ascending flanks 848, optionally at least four times as large, further optionally at least ten times as large. By increasing the amplitude of actuator movement 831 during descending flanks 849, a particularly fast slowing down of the movement according to torsional mode 502 can be achieved. This is the case because the flow of force to scan module 100 can be increased.

The slowing down of the movement of torsional mode 502 can also be achieved by a phase jump 849 in actuator movement 831. Again, this phase jump can be achieved by a phase jump in individual movements 399-1, 399-2 of piezoelectric bending actuators 310, 320. In the example of FIG. 25, phase jump 849 implements a phase offset in the deflection of each of the two bending piezo actuators 310, 320. For example, individual movement 399-1 of piezoelectric bending actuator 310 has a phase offset of 180° between ascending flank 848 and descending flank 849. Similarly, individual movement 399-2 of piezoelectric bending actuator 320 also has a phase offset of 180° between ascending flank 848 and descending flank 849. In doing so, the phase jump 849 in the resulting actuator movement 831 shown in FIG. 25 is achieved as a distance between ends 315, 325. In doing so, also an out-of-phase excitation of torsional mode 502 in the period of time of descending edge 849 compared to the period of time of ascending edge 848 is achieved, which results in the slowing down of the movement according to torsional mode 502 during descending flanks 849.

While in the example of FIG. 25, actuator movement 831 during ascending flanks 848 in each case has a constant amplitude 835, and during descending flanks 849 in each case has a constant amplitude 835, in other examples, it would also be possible that actuator movement 831 during ascending flanks 848 has a time-varying amplitude and/or during descending flanks 849 has a time-varying amplitude (not shown in FIG. 25).

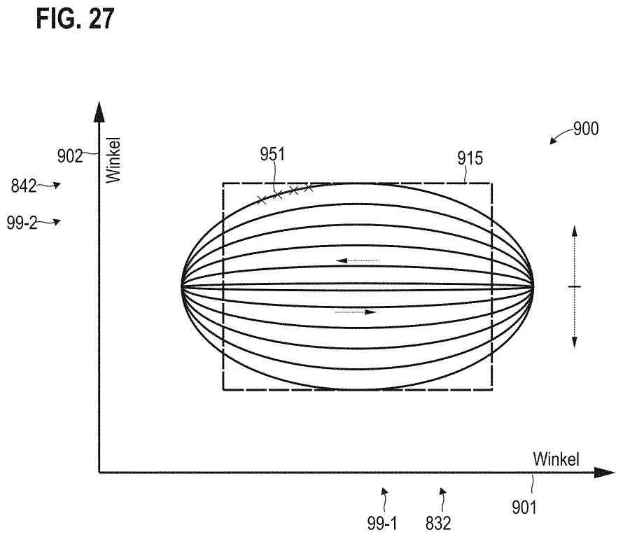

In some examples, a first scanning unit 99-1 of a scanner 90 could be operated according to the examples of FIGS. 23 and 24, and a second scanning unit 99-2 of a scanner 90 could be operated according to the examples of FIGS. 25 and 26. In other words, this means that differently actuated degrees of freedom of movement—for example, two torsional modes 502 or two transverse modes 501—can be associated with different scanning units 99-1, 99-2. This may result in a superposition figure which allows for a two-dimensional scan area. This is shown in FIG. 27.

FIG. 27 illustrates aspects relating to a superposition FIG. 900. FIG. 27 particularly illustrates aspects relating to a 2-D scan area 915 (dashed line in FIG. 27) defined by superposition FIG. 900. FIG. 27 shows scanning angle 901 which can be achieved by torsional mode 502 actuated with constant amplitude 832 (cf. FIGS. 23 and 24), for example by means of scanning unit 99-1. FIG. 27 also shows a scan angle 902 which can be achieved by torsional mode 502 actuated with amplitude modulation function 842 (see FIGS. 25 and 26), e. g., by means of scanning unit 99-2. By using two scan angles 901, 902, a radiation angle can be obtained which varies in two orthogonal spatial directions, whereby a 2-D surrounding area can be scanned.

For this purpose, for example, scanning unit 99-2 can be arranged in the beam path of light 180 between (i) scanning unit 99-1 and (ii) a detector and a light source. This means that smaller maximum amplitudes of torsional mode 502 are realized by inner scanning unit 99-2 and inner mirror 150, respectively; and larger maximum amplitudes of torsional mode 502 are realized by outer scanning unit 99-1 and outer mirror 150, respectively.

However, in other examples, a constant amplitude transverse mode 501 and a modulated amplitude transverse mode 501 could be used. In still other examples, a transverse mode 501 and a torsional mode 502 could be used. It would also be possible to use transverse modes 501 of different order. It would also be possible to use torsional modes 502 of different order.

Superposition FIG. 900 according to the example of FIG. 27 is obtained when torsional modes 502 of scanning units 99-1, 99-2 have the same frequency. This avoids nodes in superposition FIG. 900, which are otherwise typical for Lissajous scanning. In addition, superposition FIG. 900 according to the example of FIG. 27 is obtained when the amplitude of the torsional mode is increased during the ascending flanks 848 of amplitude modulation function 842. That is, it is achieved that superposition FIG. 900 is obtained as an “opening eye”, that is, larger scanning angles 901 are obtained with increasing amplitude of transverse mode 501 (represented by the vertical dotted arrows in FIG. 27). As a result, scan lines can be obtained (horizontally dotted arrows in FIG. 27) with which the surroundings of the laser scanner 99 can be sampled. Then, by repeatedly emitting light pulses, different pixels 951 can be obtained. Superposition figures with many nodes are avoided, which means that a particularly high refresh frequency can be achieved. In addition, it is avoided that certain areas between the nodes are not scanned.

Due to the fast slowing down during descending flanks 849, “the opening eye” can be quickly repeated, i. e., the superposition FIG. 900 can be implemented rapidly in a row. Dead times are reduced.

In the foregoing, techniques have been explained that use an “opening eye”, i. e., a reset of the superposition FIG. 900 is implemented by descending flanks 849. In other examples, a “closing eye” could also be used. In this case, descending flanks 849 may have a length 849A that is larger than length 848A of ascending flanks 848. The LIDAR imaging may then take place primarily or exclusively during descending flanks 849.

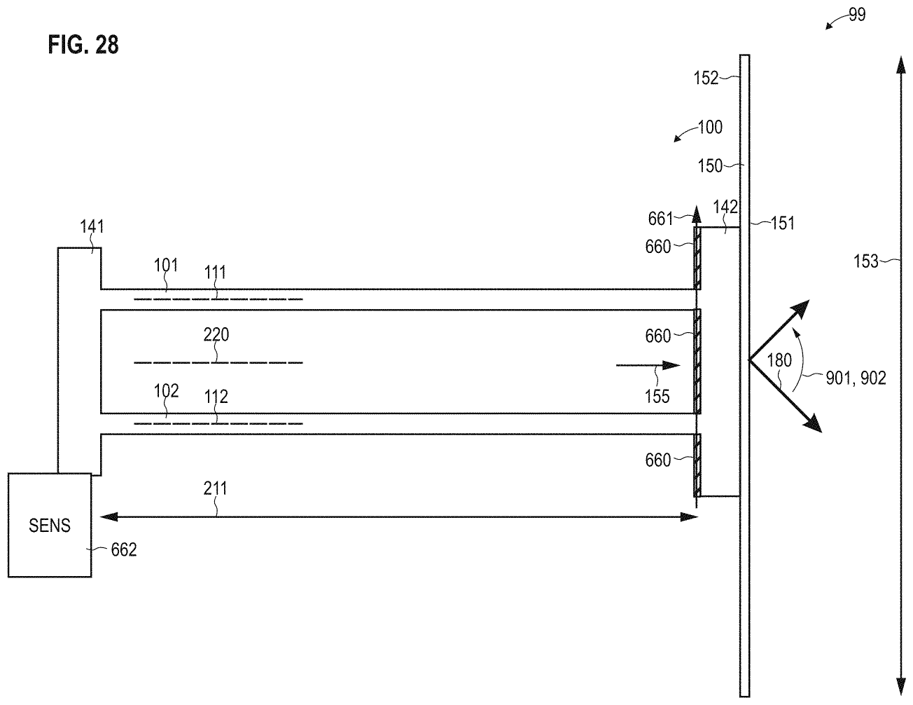

In the various examples described herein, it may be desirable to determine scan angle 901, 902 of scanning units 99, 99-1, 99-2 used particularly well. For this purpose, techniques according to the example of FIG. 28 can be used.

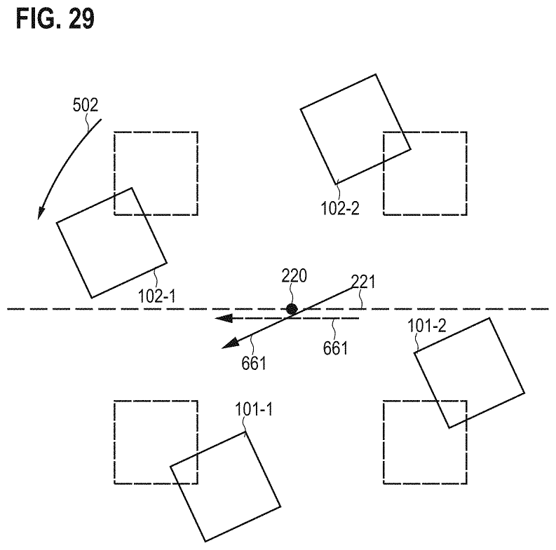

The example of FIG. 28 basically corresponds to the example of FIG. 1. In the example of FIG. 29, furthermore, a magnet 660 is applied to interface element 142. In the example of FIG. 28, magnet 660 is formed as a ferromagnetic coating. In other examples, it would also be possible for the magnet 660 to be formed, for example, as a bulk material or ferromagnetic pill.

In the example of FIG. 28 there is also provided an angular magnetic field sensor 662, which is arranged in the stray magnetic field of the magnet 660. The angular magnetic field sensor 662 outputs a signal which is indicative of torsion 502 of scan module 100. For example, the signal may be an analog signal and have a signal level that varies depending on the orientation of the stray magnetic field in the range of, for example, 0° to 360° between a minimum and a maximum. A digital signal could also be output which digitally codes the orientation of the stray magnetic field. For example, the signal may be received by a controller and used to appropriately control piezoelectric bending actuators 310, 320. For example, a loop may be implemented to accurately reproduce the superposition FIG. 900.

This allows the movement of the torsion 502 to be closely monitored. As a result, it is possible in turn to deduce the exact angle 901, 902 that is implemented by the respective scanning unit 99. As a result, a particularly high lateral resolution can be provided for a LIDAR measurement.

In the example of FIG. 28, rear side 152 of mirror 150 is arranged between mirror surface 151 and magnet 660 and the angular magnetic field sensor 162. This means that both magnet 660 and angular magnetic field sensor 662 are arranged rearwardly with respect to mirror surface 151. This means that both magnet 660 and angular magnetic field sensor 662 are arranged on a side of mirror 150 facing the rear side 152. This allows for a particularly high integration to be achieved. In addition, the angular magnetic field sensor 162 can be arranged particularly close to magnet 660, so that a high signal-to-noise ratio can be achieved. As a result, corresponding angle 901, 902 can also be determined particularly accurately. In particular, a physical separation between the optical path of light 180 and angular magnetic field sensor 662 can be achieved particularly easily because the optical path of light 180 extends on a side of mirror 150 facing front side 151. Because magnet 660 and angular magnetic field sensor 662 are arranged rearwardly with respect to mirror 150, distance 70 in the case of a scanner 90 which comprises a plurality of scanning units 99 can also be dimensioned particularly small.

In the example of FIG. 28, magnetic moment 661 of magnet 660 is arranged perpendicular to central axis 220 and to the torsional axis of torsional mode 502, respectively (see FIG. 29). In general, magnet 660 may have a magnetic moment 661 having at least one component perpendicular to the torsion axis. As a result, for example, an in-plane angular magnetic field sensor 662, which has a sensitivity in the drawing plane of FIG. 29, can be used. In other examples, an angular magnetic field sensor 662 with out-of-plane sensitivity could also be used.

In the example of FIGS. 28 and 29, magnetic moment 661 is still arranged symmetrically to central axis 220 and to the torsion axis of torsion 502, respectively. At the same time, however, angular magnetic field sensor 662 is arranged eccentrically with respect to central axis 220. This may, for example, reduce the measured signal, but allows a more flexible choice with respect to the attachment of angular magnetic field sensor 662. For example, angular magnetic field sensor 662 may be mounted radially adjacent base 141.

In the example of FIG. 28, magnet 660 is rigidly connected to mirror 150, i. e., it is arranged in the moving coordinate system; while the angular magnetic field sensor 662 is arranged in the reference coordinate system of base 141. In this way, signals of the angular magnetic field sensor 662 can be read out particularly easily because there is no need for a transfer from the moving coordinate system into the reference coordinate system—in which the controller is typically arranged. In other examples, it would also be possible that a reverse arrangement is provided, i. e., that angular magnetic field sensor 662 is arranged in the moving coordinate system and magnet 660 is arranged in the reference coordinate system of base 141. For example, then the signal of angular magnetic field sensor 662 could be transmitted wirelessly, for example by light modulation. Alternatively, it would also be possible to provide electrical conductor tracks along elastic elements 101, 102—for example by metallic coating or doping—which enable a transmission of the signals of angular magnetic field sensor 662. Such an implementation may be helpful, for example, if one and the same magnet 660 provides a stray magnetic field for a plurality of angular magnetic field sensors 662 which are associated with different scanning units 99, 99-1, 99-2 of a scanner 90 or are arranged in the moving coordinate systems of different scanning units 99, 99-1, 99-2. The different angular magnetic field sensors 662 can therefore be rigidly connected to the deflecting units of different scanning units 99, 99-1, 99-2. For example, the magnet 660 can be made particularly strong, so that a large stray magnetic field is available.

In an example according to FIG. 28—in which magnets 660 are mounted in the moving coordinate system—a simple separation of the stray magnetic fields of magnets 660 which are associated with different scanning units 99-1, 99-2 can be done as follows: at an in-plane sensitivity of angular magnetic field sensor 662 and a vertical arrangement of torsion axes 220 (cf., FIG. 16), angle magnetic field sensors 662 associated with different scanning units 99-1, 99-2 have little or no cross-sensitivity. This is the case because the corresponding stray magnetic fields rotate in planes oriented perpendicular to one another.

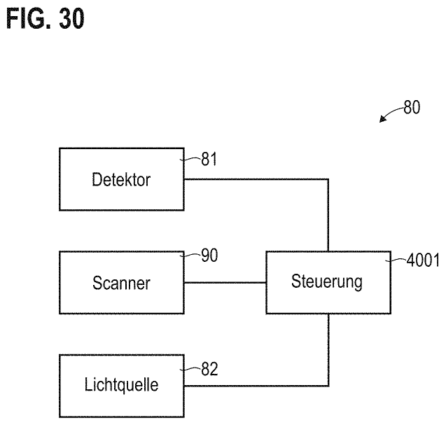

FIG. 30 illustrates aspects relating to a LIDAR system 80. LIDAR system 80 comprises a laser scanner 90 that may be configured, for example, according to the various implementations described herein. The LIDAR system also comprises a light source 81. For example, the light source 81 could be formed as a laser diode that emits pulsed laser light 180 in the near infrared region with a pulse length in the nanosecond range.

Light 180 of light source 81 may then impinge on one or more mirror surfaces 151 of scanner 90. Depending on the orientation of the deflection unit, the light is deflected at different angles 901, 902. The light emitted by light source 81 and deflected by the mirror surface of scanner 90 is often referred to as the primary light.

The primary light may then hit an environmental object of LIDAR system 80. Primary light reflected in this way is called secondary light. The secondary light may be detected by a detector 82 of LIDAR system 80. Based on a transit time—which can be determined as a time offset between the emission of the primary light by light source 81 and the detection of the secondary light by detector 82—a distance between light source 81 or detector 82 and the environmental object may be determined by means of a controller 4001.

In some examples, the emitter aperture may be equal to the detector aperture. This means that the same scanner can be used to scan the detector aperture. For example, the same mirrors can be used to emit primary light and detect secondary light. Then, a beam splitter may be provided to separate primary and secondary light. Such techniques can make it possible to achieve a particularly high sensitivity. This is the case because the detector aperture can be oriented and confined to the direction from which the secondary light comes. Ambient light is reduced by the spatial filtering, because the detector aperture can be dimensioned smaller.

Such an example may have advantages particularly in the context of periscope-like scanning. It is then possible to dimension the detector aperture particularly large—even for large scanning angles. This will be explained in detail below for detected secondary light.

In periscope-like scanning, the detector aperture defined by a single mirror—as described above—is not dependent on the scanning angle. By using the torsional mode with a torsion axis tilted at about 45° with respect to the mirror axis (cf., FIGS. 4 and 16 et seq.), the effective area of the mirror—from which light is collected and then forwarded towards the detector during scanning—is not changed. This is different with reference implementations where a mirror is tilted, see for example U.S. Pat. No. 5,614,706 A: FIG. 2.

If two mirrors are arranged one behind the other for deflecting the secondary light (cf., FIG. 16 et seq.), this combination results in a dependence of the detector aperture on the scan angle which in particular compared to the reference implementations according to U.S. Pat. No. 5,614,706 A that is comparatively small. This in turn can be motivated as follows: the outer mirror, which is located farther away from the detector with respect to the beam path of the secondary light, collects secondary light from a certain direction and deflects it in the direction of the inner mirror, which is located closer to the detector than the outer mirror. Thus, the inner mirror is arranged in the beam path of the secondary light between the outer mirror and the detector. The inner mirror is scanned also. At a large torsion angle, i. e. large scanning angle of the inner mirror, the inner mirror is twisted with respect to the outer mirror and has a smaller effective area, as described by a Cos function, according to a corresponding projection towards the outer mirror. Therefore, the larger the scanning angle of the inner mirror, the more the detector aperture is reduced. The detector aperture shows no or only a small dependence on the scan angle of the outer mirror. This results in a comparatively low dependency of the detector aperture from the scan angle, because substantially only the scanning angle of the inner mirror contributes to the reduction of the detector aperture, but not the scanning angle of the outer mirror.

This dependence can be further reduced if the maximum scanning amplitudes of the outer mirror and the inner mirror are suitably adjusted. By limiting the maximum scanning amplitude of the inner mirror—for example, compared to the maximum scanning amplitude of the outer mirror—an elliptical superposition FIG. 900 can be obtained (cf., FIG. 27, where the maximum scanning amplitude of mirror 150 of vertical scanning unit 99-2 is smaller than that of mirror 150 of horizontal scanning unit 99-1), which consistently has a comparatively large detector aperture. In particular, the dependence of the detector aperture on the scanning angle of the inner mirror is well described by a cosine function, so that especially at small scan angles no strong decrease of the detector aperture is observed (“flat top” of the Cos function). It may thus be desirable to excite the torsional mode of the degree of freedom of movement with which the outer mirror is excited, with a greater maximum amplitude than the torsional mode of the degree of freedom of movement with which the inner mirror is excited.

Thus, in a typical application, the heavily scanned outer mirror could scan with proper positioning of the scanner—such as in a vehicle—in the horizontal direction, for example (cf., FIG. 27: angle 901), and the weakly scanned inner scanner could scan in the vertical direction (cf., FIG. 27: angle 902). Typically, a comparatively large scan angle in the horizontal direction is needed, for example, to detect objects also on the side of the vehicle; while in the vertical direction no large scan angle is needed, because no objects of interest need to be detected in the sky and in the ground.

Also, in addition to this distance measurement, a lateral position of the environmental object can also be determined, for example by controller 4001. This can be done by monitoring the position or orientation of the one or more deflecting units of laser scanner 99. In this case, the position or orientation of one or more deflection units at the moment of impact of light 180 can correspond to a deflection angle 901, 902; from this it is possible to draw conclusions about the lateral position of the environmental object. For example, it may be possible to determine the position or orientation of the deflection unit based on a signal of angular magnetic field sensor 662.

By taking into account the signal of angular magnetic field sensor 662 in determining the lateral position of the environmental objects, it may be possible to determine the lateral position of the environmental objects with a particularly high accuracy. In particular, in comparison to techniques which take into account only a drive signal for controlling actuators of the movement in determining the lateral position of the environmental objects, an increased accuracy can be achieved in this way.

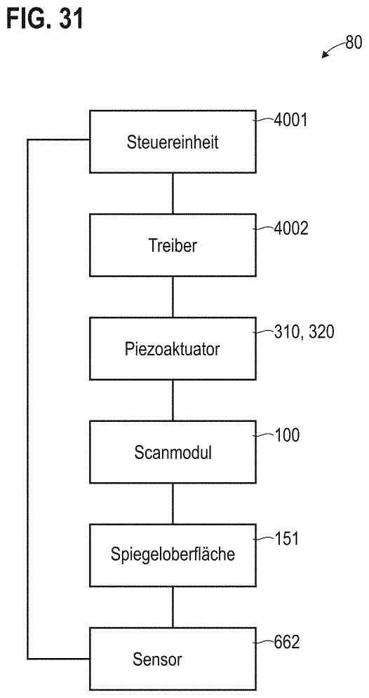

FIG. 31 illustrates aspects relating to a LIDAR system 80. LIDAR system 80 comprises a control unit 4001 that could be implemented, for example, as a microprocessor or Application Specific Integrated Circuit (ASIC). Control unit 4001 could also be implemented as a Field Programmable Array (FPGA). Control unit 4001 is configured to output control signals to a driver 4002. For example, the control signals could be output in digital or analog form.

Driver 4002 is in turn configured to generate one or more voltage signals and to output them to corresponding electrical contacts of the piezo actuators 310, 320. Typical amplitudes of the voltage signals are in the range of 50 V to 250 V.

Piezo actuators 310, 320 are in turn coupled to the scan module 100, such as described above with reference to FIGS. 5 and 6. As a result, one or more degrees of freedom of movement of scan module 100, in particular of one or more supporting elements 101, 102 of scan module 100, can be excited. As a result, the deflection is deflected. As a result, the surrounding area of laser scanner 99 can be scanned with light 180. In particular, torsional mode 502 can be excited.

Controller 4001 may be configured to suitably excite piezo actuators 310, 320 to implement a superposition figure for scanning a 2-D surrounding area. For this purpose, techniques relating to amplitude modulation function 842 can be implemented. In the example of FIG. 31, control unit 4001 may be configured in particular to drive driver 4002 or the piezoelectric bending actuators 310, 320 according to actuator movements 831 of the examples of FIGS. 23 and 25. Then, superposition FIG. 900 can be implemented.

In FIG. 31 is further illustrated that there is a coupling between control unit 4001 and angular magnetic field sensor 662. Control unit 4001 may be configured to drive the piezo actuator(s) 310, 320 based on the signal of angular magnetic field sensor 662. By such techniques, the movement of mirror surface 151 by control unit 4001 may be monitored. If needed, control unit 4001 may adjust the control of driver 4002 to reduce variations between a desired movement of mirror surface 151 and an observed movement of mirror surface 151.

For example, it would be possible for a closed-loop control to be implemented. For example, the closed-loop control could comprise the target amplitude of the movement as a reference variable. For example, the closed-loop control could comprise the actual amplitude of the movement as a control variable. In this case, the actual amplitude of the movement could be determined based on the signal of angular magnetic field sensor 662.

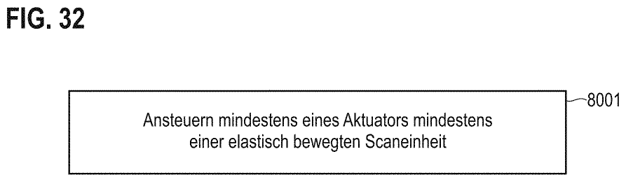

FIG. 32 is a flowchart of an exemplary method. In 8001, an actuator, such as, for example, a piezoelectric bending actuator, is controlled to excite a first degree of freedom of the movement of an elastically-moved scanning unit according to a periodic amplitude modulation function. In this case, the periodic amplitude modulation function has alternately arranged ascending flanks and descending flanks. A length of the ascending flanks can be at least twice as large as a length of the descending flanks, optionally at least four times as large, further optionally at least ten times as large.

In summary, the following examples have been described above in particular:

### Example 1

A scanner (90), comprising:
a first mirror (150) having a reflective front side (151) and a rear side (152),
a first elastic mounting (100) which extends and on a side facing the rear side (152) of the first mirror (150),
a second mirror (150) having a reflective front side (151) and a rear side (152),
a second elastic mounting (100) which extends on a side facing the rear side (152) of the second mirror (150),
wherein the scanner (90) is configured to deflect light (180) sequentially at the front side (151) of the first mirror (150) and at the front side (151) of the second mirror (150).

### Example 2

The scanner (90) according to Example 1,
wherein the first elastic mounting (100) comprises at least one elastic, rod-shaped element (101, 101-1, 101-2, 102, 102-1, 102-2), and/or
wherein the second elastic mounting (100) comprises at least one elastic rod-shaped element (101, 101-1, 101-2, 102, 102-1, 102-2).

### Example 3

The scanner (90) according to Example 2,
wherein a longitudinal axis (111, 112) of the at least one elastic rod-shaped element (101, 101-1, 101-2, 102, 102-1, 102-2) of the first elastic mounting (100) has an angle (159) of 45°±15° with a surface normal of the reflective front side (151) of the first mirror (150), and/or
wherein a longitudinal axis (111, 112) of the at least one elastic rod-shaped element (101, 101-1, 101-2, 102, 102-1, 102-2) of the second elastic mounting (100) has an angle (159) of 45°±15° with a surface normal of the reflective front side (151) of the second mirror (150).

### Example 4

The scanner (90) according to any one of the preceding examples,
wherein the first elastic mounting (100) extends along a first axis (220) in an idle state of the scanner (90),
wherein the second elastic mounting (100) extends along a second axis (220) in the idle state of the scanner (90),
wherein the first axis joins the second axis at an angle of 90°±25°, optionally 90°±1°, further optionally 90°±0.1°.

### Example 5

The scanner (90) according to any one of Examples 1-4,
wherein the first elastic mounting (100) extends along a first axis (220) in an idle state of the scanner (90),
wherein the second elastic mounting (100) extends along a second axis (220) in the idle state of the scanner (90),
wherein the first axis joins the second axis at an angle of 180°±25°, optionally 180°±1°, further optionally 180°±0.1°.

### Example 6

The scanner (90) according to any one of the preceding examples,
wherein a length of the first elastic mounting (100) is in the range of 20%-400% of a diameter of the reflective front side (151) of the first mirror (150), and/or
wherein a length of the second elastic mounting (100) is in the range of 20%-400% of a diameter of the reflective front side (151) of the second mirror (150).

### Example 7

The scanner (90) according to any one of the preceding examples,
wherein a distance (70) between a center of the reflective front side (151) of the first mirror (150) and a center of the reflective front side (151) of the second mirror (150) in an idle state of the scanner (90) is not greater than 4 times the diameter (153) of the reflective front side (151) of the first mirror (150), optionally not greater than 3 times the diameter, further optionally not greater than 1.8 times the diameter.

### Example 8

The scanner (90) of any one of the preceding examples, further comprising:
a first actuator (310, 320) configured to excite a degree of freedom of movement of the first elastic mounting (100), and
a second actuator (310, 320) configured to excite a degree of freedom of movement of the second elastic mounting (100),
wherein the degree of freedom of movement of the first elastic mounting (100) comprises a torsional mode (502),
wherein the degree of freedom of movement of the second elastic mounting (100) comprises a torsional mode (502).

### Example 9

The scanner (90) according to any one of the preceding examples, further comprising:
a first pair of piezo actuators (310, 320) mounted on an end (141) of the first elastic mounting (100) facing away from the rear side (152) of the first mirror (150), and/or
a second pair of piezo actuators (310, 320) mounted on an end (141) of the second elastic mounting (100) facing away from the rear side (152) of the second mirror (150).

### Example 10

The scanner (90) according to any one of the preceding examples,
wherein the first elastic mounting (100) secures the first mirror (150) to a base as a 1-point mounting, and/or
wherein the second elastic mounting (100) secures the second mirror (150) to the base as a 1-point mounting.

Of course, the features of the embodiments described above and aspects of the invention may be combined. In particular, the features may be used not only in the described combinations but also in other combinations or per se, without departing from the scope of the invention.

For example, techniques have been described above in which a superposition figure is implemented with short descending flanks and long ascending flanks. Accordingly, it would also be possible, for example, to use comparatively long descending flanks and comparatively short ascending flanks; for example, in such an example, it might be possible for LIDAR imaging to take place substantially during the comparatively long descending flanks. In some examples, it would also be possible to use equally long ascending and descending flanks; even in such cases, efficient scanning can be ensured by a suitable implementation of the superposition figure, for example without or with just a few nodes.

Furthermore, techniques have been described above in which two time-overlapping degrees of freedom of movement are excited at the same frequency. However, in some examples, it would also be possible for a first degree of freedom of movement to be excited at a first frequency and for a second degree of freedom of movement to be excited at a second frequency different from the first frequency, for example, greater by a factor of two. In doing so a superposition figure can have a node, for example, which may reduce the efficiency of scanning of the surrounding area, but at the same time may make the choice of the degrees of freedom of movement more flexible.

Furthermore, various examples have been described above relating to a superposition figure described by temporally superposing a first torsional mode which is associated with a first scanning unit, and a second torsional mode which is associated with a second scanning unit. However, corresponding techniques can also be implemented if, for example, two transverse modes which are associated with different scanning units are used.

Furthermore, various techniques have been described above relating to the movement of scanning units in conjunction with LIDAR measurements. Corresponding techniques can also be employed in other applications, e. g. for projectors or laser scanning microscopes, etc.

1. A scanner, comprising:
a first mirror comprising a reflective front side and a rear side,
a first elastic mounting which extends away from a rear side of the first mirror and on a side facing the rear side of the first mirror,
a second mirror comprising a reflective front side and a rear side,
a second elastic mounting which extends away from a rear side of the second mirror and on a side facing the rear side of the second mirror,
a first actuator configured to excite a degree of freedom of movement of the first elastic mounting, and
a second actuator configured to excite a degree of freedom of movement of the second elastic mounting,
wherein the degree of freedom of movement of the first elastic mounting comprises a torsional mode,
wherein the degree of freedom of movement of the second elastic mounting comprises a torsional mode, and
wherein the scanner is configured to deflect light sequentially at the front side of the first mirror and at the front side of the second mirror.

2. The scanner according to claim 1,
wherein the first elastic mounting comprises at least one elastic, rod-shaped element, and/or
wherein the second elastic mounting comprises at least one elastic rod-shaped element.

3. The scanner according to claim 2,
wherein a longitudinal axis of the at least one elastic rod-shaped element of the first elastic mounting has an angle of 45°±15° with a surface normal of the reflective front side of the first mirror, and/or
wherein a longitudinal axis of the at least one elastic rod-shaped element of the second elastic mounting has an angle of 45°±15° with a surface normal of the reflective front side of the second mirror.

4. The scanner according to claim 2,
wherein a first torsion axis of the torsional mode of the first elastic mounting is parallel to a central axis of the at least one elastic rod-shaped element of the first elastic mounting, and
wherein a second torsion axis of the torsional mode of the second elastic mounting is parallel to a central axis of the at least one elastic rod-shaped element of the second elastic mounting.

5. The scanner according to claim 1,
wherein the first mirror is scanned periscope-like, and
wherein the second mirror is scanned periscope-like.

6. The scanner according to claim 1, further comprising:
a light source,
a detector,
wherein the light comprises primary light from the light source and further comprises secondary light for a detector, and
wherein the first mirror and the second mirror are configured to both emit the primary light and detect the secondary light.

7. The scanner according to claim 6,
wherein an emitter aperture that is defined by the first mirror and the second mirror and is associated with the light source is equal to a detector aperture that is defined by the first mirror and the second mirror and is associated with the detector.

8. The scanner according to claim 6,
wherein the first mirror is arranged in the beam path of the secondary light between the second mirror and the detector,
wherein the first actuator is configured to excite the torsional mode of the first degree of freedom of movement at a first maximum amplitude,
wherein the second actuator is configured to excite the torsional mode of the second degree of freedom of movement at a second maximum amplitude, and
wherein the first amplitude is smaller than the second amplitude.

9. The scanner according to claim 1,
wherein the scanner is configured to scan surroundings of the scanner vertically by means of the first mirror, and
wherein the scanner is configured to scan the surroundings of the scanner horizontally by means of the second mirror.

10. The scanner according to claim 1,
wherein the first elastic mounting extends along a first axis in an idle state of the scanner,
wherein the second elastic mounting extends along a second axis in the idle state of the scanner, and
wherein the first axis joins the second axis at an angle of 90°±25°.

11. The scanner according to claim 1,
wherein the first elastic mounting extends along a first axis in an idle state of the scanner,
wherein the second elastic mounting extends along a second axis in the idle state of the scanner, and
wherein the first axis joins the second axis at an angle of 180°±25°.

12. The scanner according to claim 1,
wherein a length of the first elastic mounting is in the range of 20%-400% of a diameter of the reflective front side of the first mirror, and/or
wherein a length of the second elastic mounting is in the range of 20%-400% of a diameter of the reflective front side of the second mirror.

13. The scanner according to claim 1,
wherein a distance between a center of the reflective front side of the first mirror and a center of the reflective front side of the second mirror in an idle state of the scanner is not greater than 4 times the diameter of the reflective front side of the first mirror.

14. The scanner according to claim 1, further comprising:
a first pair of piezo actuators mounted on an end of the first elastic mounting facing away from the rear side of the first mirror, and/or
a second pair of piezo actuators mounted on an end of the second elastic mounting facing away from the rear side of the second mirror.

15. The scanner according to claim 1,
wherein the first elastic mounting secures the first mirror to a base as a 1-point mounting, and/or
wherein the second elastic mounting secures the second mirror to the base as a 1-point mounting.

16. The scanner according to claim 1,
wherein the first actuator is configured to resonantly excite the degree of freedom of movement of the first elastic mounting,
wherein the second actuator is configured to resonantly excite the degree of freedom of movement of the second elastic mounting.
